(19) United States
(12) Patent Application Publication
(10) Pub. No.: US 2015/0085766 A1
(43) Pub. Date: Mar. 26, 2015

(54) METHOD FOR MULTIPLEXING CONTROL INFORMATION AT BASE STATION IN WIRELESS COMMUNICATION SYSTEM AND APPARATUS FOR THE SAME

(71) Applicants: Kitae Kim, Anyang-si (KR); Jinyoung Chun, Anyang-si (KR); Sunam Kim, Anyang-si (KR); Jiwon Kang, Anyang-si (KR); Binchul Ihm, Anyang-si (KR); Sungho Park, Anyang-si (KR)

(72) Inventors: Kitae Kim, Anyang-si (KR); Jinyoung Chun, Anyang-si (KR); Sunam Kim, Anyang-si (KR); Jiwon Kang, Anyang-si (KR); Binchul Ihm, Anyang-si (KR); Sungho Park, Anyang-si (KR)

(73) Assignee: LG ELECTRONICS INC., Seoul (KR)

(21) Appl. No.: 14/342,336

(22) PCT Filed: Jul. 6, 2012
(86) PCT No.: PCT/KR2012/005369

§ 371 Date: Feb. 28, 2014

Related U.S. Application Data
(60) Provisional application No. 61/545,577, filed on Oct. 10, 2011.
(60) Provisional application No. 61/547,053, filed on Oct. 14, 2011.

(51) Int. Cl. H04W 72/04

(52) U.S. Cl. CPC H04W 72/042
USPC 370/329

(57) ABSTRACT

A method for transmitting a downlink control channel at a base station in a wireless communication system is disclosed herein. The method includes the steps of generating control information for each of a plurality of user equipments; mapping the control information for each of the plurality of user equipments to one of subcarrier groups within at least one resource block pairs configured for the downlink control channel, wherein the subcarrier groups mapped to the control information for each of the plurality of user equipments are different from each other; and transmitting the downlink control channel through the subcarrier groups.

### TECHNICAL FIELD

The present invention relates to a wireless communication system and, more particularly, to a method for multiplexing control information at a base station in a wireless communication system and an apparatus for the same.

### BACKGROUND ART

As an example of a communication system to which the present invention may be applied, a 3GPP LTE (3^{rd} Generation Partnership Project Long Term Evolution; hereinafter referred to as “LTE”) communication system will now be broadly described.

FIG. 1 illustrates a general view of an E-UMTS network structure as an example of a communication system. Herein, the E-UMTS (Evolved Universal Mobile Telecommunications System) corresponds to a system evolved from the conventional UMTS (Universal Mobile Telecommunications System). The 3GPP is presently carrying out a basic standardization process for the E-UMTS. Generally, the E-UMTS may also be referred to as an LTE system. For details of the technical specifications of the UMTS and the E-UMTS, reference may be made to Release 7 and Release 8 of “3rd Generation Partnership Project; Technical Specification Group Radio Access Network”.

Referring to FIG. 1, the E-UMTS includes a User Equipment (UE), base stations (eNode B; eNB), and an Access Gateway (AG), which is located at an end of a network (E-UTRAN) and connected to an external network. The base stations can simultaneously transmit multiple data streams for a broadcast service, a multicast service and/or a unicast service.

One or more cells may exist for one base station. One cell is set to one of bandwidths of 1.44, 3, 5, 10, 15, and 20 Mhz to provide a downlink or uplink transport service to several user equipments. Different cells may be set to provide different bandwidths. Also, one base station controls data transmission and reception for a plurality of user equipments. The base station transmits Downlink (DL) scheduling information of downlink data to the corresponding user equipment to notify information related to time and frequency domains to which data will be transmitted, encoding, data size, and HARQ (Hybrid Automatic Repeat and reQuest). Also, the base station transmits Uplink (UL) scheduling information of uplink data to the corresponding user equipment to notify information related to time and frequency domains that can be used by the corresponding user equipment, encoding, data size, and HARQ. An interface for transmitting user traffic or control traffic can be used between the base stations. A Core Network (CN) may include the AG and a network node or the like for user registration of the UE. The AG manages mobility of a UE on a TA (Tracking Area) unit basis, wherein one TA unit includes a plurality of cells.

The wireless communication technology has been developed up to the LTE based upon WCDMA. However, the demands and expectations of the users and the manufacturers and providers are growing continuously. Also, since other wireless access technologies are constantly being developed, the wireless communication technology is required to newly evolve in order to ensure competiveness in the future. Accordingly, characteristics, such as reduced cost for each bit, extension of a service availability, usage of a flexible frequency band, simple structure and open interface, and adequate power consumption of the user equipment are being requested.

### DISCLOSURE

### Technical Problem

Based upon the discussion presented above, an object of the present invention is to propose a method of a base station for multiplexing control information in a wireless communication system and an apparatus for the same.

The technical objects of the present invention will not be limited only to the objects described above. Accordingly, additional technical objects of the present application will be set forth in part in the description which follows and in part will become apparent to those having ordinary skill in the art upon examination of the following or may be learned from practice of the present application.

### Technical Solution

In an aspect of the present invention, a method of a base station for transmitting a downlink control channel in a wireless communication system may include the steps of generating control information for each of a plurality of user equipments; mapping the control information for each of the plurality of user equipments to one of subcarrier groups within at least one resource block pairs configured for the downlink control channel, wherein the subcarrier groups mapped to the control information for each of the plurality of user equipments are different from each other; and transmitting the downlink control channel through the subcarrier groups. Preferably, the control information for each of the plurality of user equipments is mapped to a data region of the at least one resource block pairs.

Herein, a size of the subcarrier group is configured independently for each of the plurality of user equipments.

Also, the control information for each of the plurality of the user equipments is mapped to one of the subcarrier groups in a unit of Control Channel Element (CCE), and the number of resource elements comprising the CCE is independently configured for each of the plurality of user equipments.

Furthermore, the method may further include a step of transmitting a reference signal for each of the plurality of user equipments. In this case, the reference signal for each of the plurality of user equipments is mapped to the subcarrier group, to which the control information for a corresponding user equipment is mapped, within the at least one resource block pairs.

Meanwhile, according to another aspect of the present invention, a base station device in a wireless communication system includes a processor configured to generate control information for each of a plurality of user equipments, and to map the control information for each of the plurality of user equipments to one of subcarrier groups within at least one resource block pairs configured for the downlink control channel, wherein the subcarrier groups mapped to the control information for each of the plurality of user equipments are different from each other; and a wireless communication module configured to transmit the downlink control channel through the subcarrier groups. Preferably, the processor maps the control information for each of the plurality of user equipments to a data region of the at least one resource block pairs.

Herein, the processor independently configures a size of the subcarrier group for each of the plurality of user equipments.

Additionally, the processor maps the control information for each of the plurality of the user equipments to the subcarrier groups in a unit of Control Channel Element (CCE), and the processor configures the number of resource elements comprising the CCE independently for each of the plurality of user equipments.

More preferably, the wireless communication module transmits a reference signal for each of the plurality of user equipments. In this case, the processor maps the reference signal for each of the plurality of user equipments to the subcarrier group, to which the control information for a corresponding user equipment is mapped, within the at least one resource block pairs.

### Advantageous Effects

According to the embodiments of the present invention, in a wireless communication system, the base station may efficiently multiplex control information and transmit the multiplexed control information via downlink.

Additional effects of the present application will be set forth in part in the description which follows and in part will become apparent to those having ordinary skill in the art upon examination of the following or may be learned from practice of the present application.

### DESCRIPTION OF DRAWINGS

FIG. 1 illustrates a general view of an E-UMTS network structure as an example of a communication system.

FIG. 2 illustrates a Control Plane structure and a User Plane structure of a Radio Interface Protocol between a user equipment and the E-UTRAN based upon the 3GPP radio access network standard.

FIG. 3 illustrates physical channels that are used in the 3GPP system and a general method for transmitting signals using such physical channels.

FIG. 4 illustrates a block view showing the structure of a multiple antenna communication system.

FIG. 5 illustrates an exemplary structure of a downlink radio frame that is used in the LTE system.

FIG. 6 illustrates a resource unit that is used for configuring a downlink control channel in the LTE system.

FIG. 7 illustrates an exemplary structure of an uplink radio frame that is used in the LTE system.

FIG. 8 illustrates a block view showing the configuration of a relay backhaul link and a relay access link in a wireless communication system.

FIG. 9 illustrates an exemplary relay node resource division.

FIG. 10 illustrates an example of a multiple node system in a next generation communication system.

FIG. 11 illustrates an exemplary E-PDCCH and an exemplary PDSCH, which is being scheduled by the E-PDDCH.

FIG. 12 illustrates an exemplary structure of an R-PDCCH being transmitted to a relay node.

FIG. 13 illustrates an example of allocating (or assigning) an E-PDCCH in accordance with a related art 1).

FIG. 14 illustrates an example of allocating (or assigning) an E-PDCCH in accordance with a related art 2).

FIG. 15 illustrates an example of an E-PDCCH, which is multiplexed in accordance with a first exemplary embodiment of the present invention.

FIG. 16 illustrates an example of allocating (or assigning) a DM-RS port for each user equipment, in order to multiplex the E-PDCCH in accordance with the first exemplary embodiment of the present invention.

FIG. 17 illustrates an example of an E-PDCCH, which is multiplexed in accordance with a second exemplary embodiment of the present invention.

FIG. 18 illustrates another example of an E-PDCCH, which is multiplexed in accordance with the second exemplary embodiment of the present invention.

FIG. 19 illustrates an example of an E-PDCCH, which is multiplexed in accordance with a third exemplary embodiment of the present invention.

FIG. 20 illustrates another example of an E-PDCCH, which is multiplexed in accordance with the third exemplary embodiment of the present invention.

FIG. 21 illustrates an example of allocating (or assigning) a DM-RS port for each user equipment, in order to multiplex the E-PDCCH in accordance with the third exemplary embodiment of the present invention.

FIG. 22 illustrates a block view showing the structure of a communication device according to an exemplary embodiment of the present invention.

### MODE FOR INVENTION

Hereinafter, reference will now be made in detail to the preferred embodiments of the present invention, examples of which are illustrated in the accompanying drawings. The detailed description of the present invention is provided to facilitate the understanding of the configuration, operation, and other characteristics of the present invention. The following embodiments of the present invention correspond to examples wherein the technical features of the present invention are applied in the 3GPP system.

In the detailed description of the present invention, although the exemplary embodiment of the present invention is described by using an LTE system and an LTE-A system, this is merely exemplary. However, the exemplary embodiment of the present invention may be applied to any type of communication system corresponding to the above-described definition. Furthermore, although the exemplary embodiment of the present invention is described herein based upon an FDD method, this is also merely exemplary. Therefore, the exemplary embodiment of the present invent may be easily modified to be applied to an H-FDD method or a TDD method.

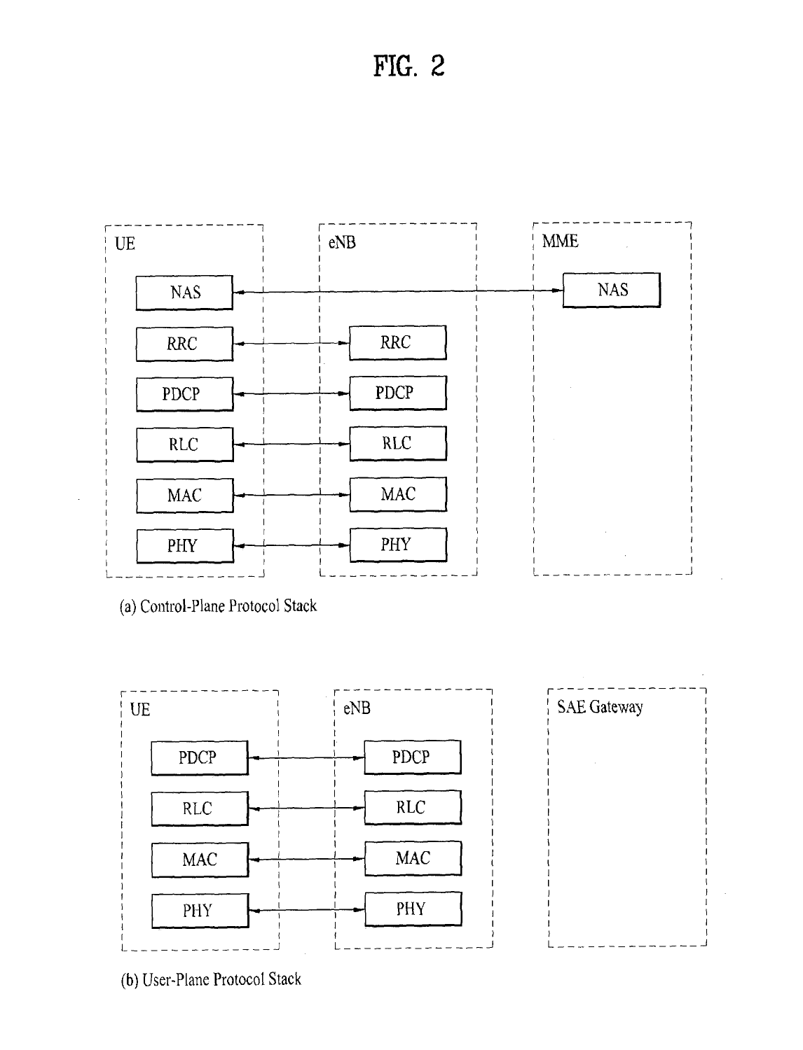

FIG. 2 illustrates a Control Plane structure and a User Plane structure of a Radio Interface Protocol between a user equipment and the E-UTRAN based upon the 3GPP radio access network standard. A control plane refers to a path through which control messages are transmitted. Herein, the control messages are used by the User Equipment (UE) and network in order to manage a unit. And, a user plane refers to a path through which data generated from an application layer are transmitted. Such data may include audio data or Internet packet data, and so on.

A first layer, which corresponds to a physical layer, uses a physical channel to provide an Information Transfer Service to a higher layer. The physical layer is connected to a Medium Access Control layer, which corresponds to a higher layer, through a Transport Channel. And, herein, data is transported between the Medium Access Control layer and the physical layer through the Transport Channel. In a data transmission between a physical layer of the transmitting end and a physical layer of the receiving end, data are transported between the physical layers through a physical channel. Herein, the physical layer uses time and frequency as radio resource. More specifically, in a downlink, the physical channel is modulated by using an OFDMA (Orthogonal Frequency Division Multiple Access) scheme, and, in an uplink, the physical channel is modulated by using an SC-FDMA (Single Carrier Frequency Division Multiple Access) scheme.

A Medium Access Control (MAC) layer of a second layer provides services to a Radio Link Control (RLC) layer, which corresponds to higher layer, through a logical channel. The Radio Link Control (RLC) layer of the second layer supports the transmission of reliable data. The function of the RLC layer may also be realized by a functional block within the MAC. A PDCP (Packet Data Convergence Protocol) layer of the second layer performs a header compression function, which can reduce unnecessary control information in order to efficiently transmit IP packets, such as IPv4 or IPv6, in a wireless (or radio) interface having a narrow bandwidth.

A Radio Resource Control (RRC) layer which is positioned in a lowermost portion of a third layer is defined only in the control plane. And, in relation with the configuration, re-configuration, and release of radio bearers (RBs), the RRC layer performs the role of controlling the logical channels, the transmission channels, and the physical channels. The Radio Bearer refers to a service that is provided by the second layer in order to deliver (or transport) data between the UE and the network. In order to do so, the RRC layers of the UE and the network exchanges RRC messages to and from one another. If an RRC connection exists between the RRC layer of the UE and the RRC layer of the network, the user equipment is in an RRC Connected Mode. And, if not, the user equipment is in an RRC Idle Mode. An NAS (Non-Access Stratum) layer, which is located above the RRC layer performs the roles of Session Management and Mobility Management.

One cell that configures a base station (eNB) is set to one of bandwidths of 1.4, 3, 5, 10, 15, 20 Mhz, thereby providing a downlink or uplink transport service to several user equipments. Different cells may be set to provide different bandwidths.

In the network, downlink transmission channels that transmit data to the UE include a BCH (Broadcast Channel), which transmits system information, a PCH (Paging Channel), which transmits paging messages, and a downlink SCH (Shared Channel), which transmits information other than the system information, such as user traffic or control messages. In case of traffic information or control messages of a downlink multicast or broadcast service, the corresponding data may be transmitted through a downlink SCH or may also be transmitted through a separate downlink MCH (Multicast Channel). Meanwhile, uplink transmission channels that transmit data from the UE to the network include a RACH (Random Access Channel), which transmits initial control messages, and an uplink SCH (Shared Channel), which transmits information other than the system information, such as user traffic or control messages. Logical Channels being in a level higher than the transmission channel and being mapped to the transmission channel include a BCCH (Broadcast Channel), a PCCH (Paging Control Channel), a CCCH (Common Control Channel), an MCCH (Multicast Control Channel), an MTCH (Multicast Traffic Channel), and so on.

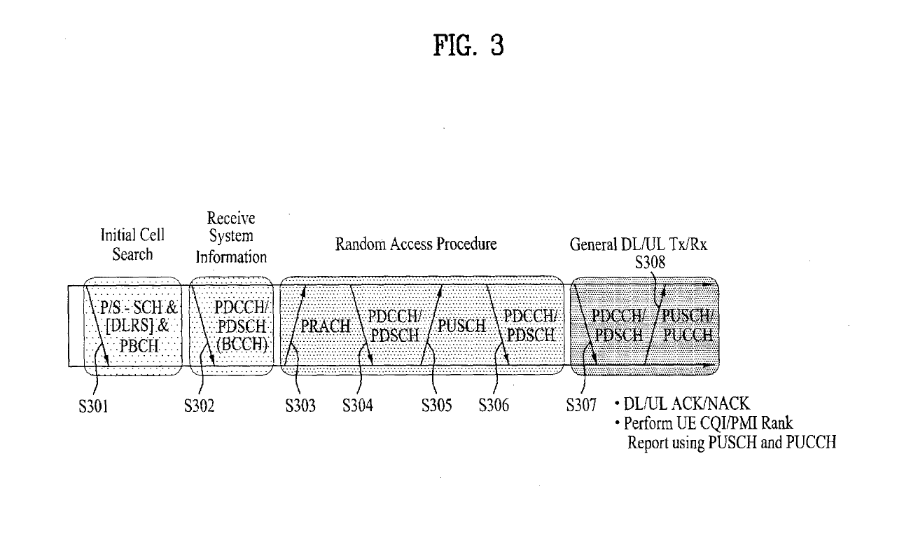

FIG. 3 illustrates physical channels that are used in the 3GPP system and a general method for transmitting signals using such physical channels.

The user equipment performs initial cell search such as synchronization with the base station, when it newly enters a cell or when the power is turned on (S301). In order to do so, the user equipment synchronizes with the base station by receiving a Primary Synchronization Channel (P-SCH) and a Secondary Synchronization Channel (S-SCH) from the base station, and then acquires information such as cell ID, and so on. Thereafter, the user equipment may acquire broadcast information within the cell by receiving a Physical Broadcast Channel from the base station. Meanwhile, in the step of initial cell search, the user equipment may receive a Downlink Reference Signal (DL RS) so as to verify the downlink channel status.

Once the user equipment has completed the initial cell search, the corresponding user equipment may acquire more detailed system information by receiving a Physical Downlink Control Channel (PDCCH) and a Physical Downlink Control Channel (PDSCH) based upon the respective information carried in the PDCCH (S302).

Meanwhile, if the user equipment initially accesses the base station, or if there are no radio resources for signal transmission, the user equipment may perform a Random Access Procedure (RACH) with respect to the base station (S303 to S306). In order to do so, the user equipment may transmit a specific sequence to a preamble through a Physical Random Access Channel (PRACH) (S303 and S305), and may receive a response message respective to the preamble through the PDCCH and the PDSCH corresponding to the PDCCH (S304 and S306). In case of a contention based RACH, a Contention Resolution Procedure may be additionally performed.

After performing the above-described process steps, the user equipment may perform PDCCH/PDSCH reception (S307) and Physical Uplink Shared Channel (PUSCH)/Physical Uplink Control Channel (PUCCH) transmission (S308), as general uplink/downlink signal transmission procedures. Most particularly, the user equipment receives Downlink Control Information (DCI) through the PDCCH. Herein, the DCI includes control information, such as resource allocation (or assignment) information respective to the corresponding user equipment, and each format of the DCI may differ from one another depending upon the purpose of the corresponding DCI.

Meanwhile, the control information, which is transmitted by the user equipment to the base station or received by the user equipment from the base station via uplink, includes downlink/uplink ACK/NACK signals, a CQI (Channel Quality Indicator), a PMI (Precoding Matrix Index), an RI (Rank Indicator), and so on. In case of the 3GPP LTE system, the user equipment may transmit control information, such as the above-described CQI/PMI/RI through the PUSCH and/or the PUCCH.

Hereinafter, the MIMO system will be described in detail. Herein, the MIMO (Multiple-Input Multiple-Output) method refers to a method of using multiple transmission antennae and multiple reception antennae. By using this method, the data transmission and reception efficiency may be enhanced. More specifically, by having a transmitting end or receiving end of the wireless communication system use multiple antennae, the system capacity may be extended, and the system performance may be enhanced. Hereinafter, in this document, MIMO will also be referred to as ‘multiple antenna’.

The multiple antenna technique (or method) does not rely on a single antenna path in order to receive an entire single message. Instead, the multiple antenna technique completes an entire set of data by integrating a plurality of data fragments that is respectively received through multiple antennae. By using the multiple antenna technique, the data transmission speed (or rate) within a cell region of a specific size may be enhanced, or the system coverage may be extended while ensuring a specific data transmission speed (or rate). Additionally, this technique (or method) may be broadly used in mobile communication devices (or terminals or user equipments) and relay nodes (or relay stations), and so on. And, by applying the multiple antenna technique, the system may overcome the limitations in the transmission amount in the related art mobile communication, wherein the single antenna method is used.

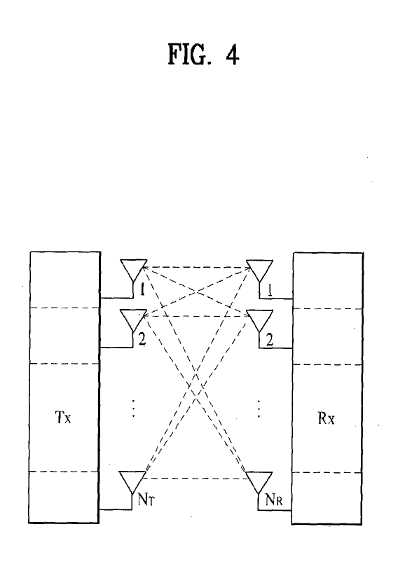

A block view showing the structure of the multiple antenna (MIMO) communication system, which is presented in the description of the present invention, is shown in FIG. 4. Herein, N_{T} number of transmission antennae is installed in the transmitting end, and N_{R} number of reception antennae is installed in the receiving end. As described above, when both the transmitting end and the receiving end use multiple antennae, the logical channel transmission capacity increases as compared to when only one of the transmitting end and the receiving end uses multiple antennae. The increase in the channel transmission capacity is proportional to the number of antennae used in the system. Accordingly, the transmission rate is enhanced, and a frequency efficiency is also enhanced In case a single antenna is being used, when a maximum transmission rate is referred to as Rₒ, the maximum rate when using multiple antennae may be theoretically increased as much as multiplying the maximum transmission rate Rₒ by a rate increase ratio Rᵢ, as shown in Equation 1. Herein, Rᵢ corresponds to the smaller value between N_{T} and N_{R}.

Rᵢ=min(N_{T},N_{R}) [Equation 1]

For example, a MIMO communications system using 4 transmitting antennae and 4 receiving antennae may theoretically gain a transmission rate 4 times greater than that of a single antenna system. After the theoretical capacity increase of a multi antennae system has been proven in the mid 90s, diverse technologies for realizing a substantial enhancement in the data transmission rate is still under active research and development. Moreover, among such researches, some of the technologies are already being reflected and applied in diverse standards in wireless communication, such as the 3^{rd} generation mobile communications, the next generation wireless LAN, and so on.

Referring to the trend in the many researches on multi antennae up to the most recent research, research and development on a wide range of perspectives have been actively carried out, wherein the fields of research include research in the aspect of information theory associated with multi antennae communication capacity calculation, research in wireless (or radio) channel measurement and drawing out models, research in time-spatial signal processing technology for enhancing transmission reliability and enhancing transmission rate, and so on, in diverse channel environments and multiple access environments.

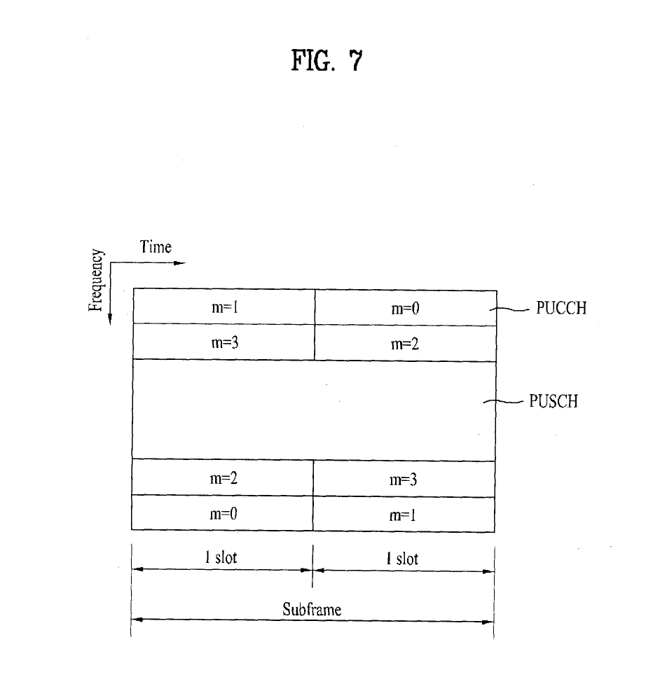

In order to provide a more detailed description on the communication method in a multi antennae system, the corresponding communication method may be expressed as shown below, when performing mathematical modeling. As shown in FIG. 7, it will be assumed that N_{T} number of transmitting antennae and N_{R} number of receiving antennae in the system. First of all, referring to a transmitted signal, when there is N_{T} number of transmitting antennae, the maximum number of transmittable information is equal to N_{T}. And, therefore, the transmission information may be expressed in the form of a vector as shown below in Equation 2.

s=└s₁,s₂, . . . ,s_{N}_{_{T}}┘^{T} [Equation 2]

Meanwhile, each of the transmission information s₁, s₂, . . . , s_{N}_{_{T}} may be assigned with a different transmission power. At this point, when each of the transmission power is referred to as P₁, P₂, . . . , P_{N}_{_{T}}, the transmission information having its respective transmission power adjusted may be expressed in the form of a vector as shown below in Equation 3.

ŝ=[ŝ₁,ŝ₂, . . . ,ŝ_{N}_{_{T}}]^{T}=[P₁s₁,P₂s₂, . . . ,P_{N}_{_{T}}s_{N}_{_{T}}]^{T} [Equation 3]

Moreover, by using a diagonal matrix P of the transmission power, Ŝ may be expressed as shown below in Equation 4.

$$\hat{s} = [ \begin{matrix}{P}_{1} & & & 0 \\ & {P}_{2} & & \\ & & ⋱ & \\ 0 & & & {P}_{{N}_{r}}\end{matrix} ] [ \begin{matrix}{s}_{1} \\ {s}_{2} \\ ⋮ \\ {s}_{{N}_{r}}\end{matrix} ] = Ps \qquad [ Equation 4 ]$$

Meanwhile, a case wherein N_{T} number of transmitted signals x₁, x₂, . . . , x_{N}_{_{T}}, which are configured by having a weight matrix W applied to an information vector Ŝ, wherein the transmission power is adjusted, so that the transmitted signals can actually be transmitted, will be considered. Herein, the weight matrix performs the role of adequately distributing transmission information to each antenna in accordance with the transmission channel status. Such transmitted signals x₁, x₂, . . . , x_{N}_{_{T}} may be expressed as shown below in Equation 5, by using a vector X. Herein, Wᵢⱼ represents a weight between an i^{th} transmitting antenna and a j^{th} information. W may also be referred to as a Weight Matrix or a Precoding Matrix.

$$x = [ \begin{matrix}{x}_{1} \\ {x}_{2} \\ ⋮ \\ {x}_{i} \\ ⋮ \\ {x}_{{N}_{T}}\end{matrix} ] = [ \begin{matrix}{w}_{11} & {w}_{12} & ⋯ & {w}_{1 {N}_{T}} \\ {w}_{21} & {w}_{22} & ⋯ & {w}_{2 {N}_{T}} \\ ⋮ & & ⋱ & \\ {w}_{i 1} & {w}_{i 2} & ⋯ & {w}_{i {N}_{T}} \\ ⋮ & & ⋱ & \\ {w}_{{N}_{T} 1} & {w}_{{N}_{T} 2} & ⋯ & {w}_{{N}_{T} {N}_{T}}\end{matrix} ] [ \begin{matrix}{\hat{s}}_{1} \\ {\hat{s}}_{2} \\ ⋮ \\ {\hat{s}}_{J} \\ ⋮ \\ {\hat{s}}_{{N}_{T}}\end{matrix} ] = W \hat{s} = WPs \qquad [ Equation 5 ]$$

Generally, the physical definition of a channel matrix rank may correspond to a maximum number of different sets of information that may be transmitted from a given channel. Therefore, a rank of a matrix is defined as a minimum number among the number of rows or columns that are independent from one another. Therefore, the rank of a matrix cannot be greater than the number of rows or the number of columns. When expressed in the form of an equation, the rank (rank(H)) of the channel matrix H may be limited as shown below in Equation 6.

rank(H)≦min(N_{T},N_{R}) [Equation 6]

Additionally, herein, each of the different sets of information being transmitted by using the multiple antenna technique will be defined as a ‘transmission stream’ or simply as a ‘stream’. Such ‘stream’ may also be referred to as a ‘Layer’. Evidently, the number of transmission streams cannot be greater than the channel rank, which corresponds to the maximum number of different information sets. Accordingly, the channel matrix H may be expressed as shown below in Equation 7.

# of streams≦rank(H)≦min(N_{T},N_{R}) [Equation 7]

Herein, the ‘# of streams’ indicates the number of streams. Meanwhile, it should be noted herein that a single stream may be transmitted through one or more antennae.

Diverse methods may exist for matching one or more streams to multiple antennae. Such methods may be described below in more detailed based upon the different types of the multiple antenna technique. When a single stream is being transmitted over multiple antennae, this may be referred to as a spatial diversity method. And, when multiple streams are being transmitted over multiple antennae, this may be referred to as a spatial multiplexing method. Evidently, an intermediate method, which corresponds to a Hybrid format of spatial diversity and spatial multiplexing may also be used.

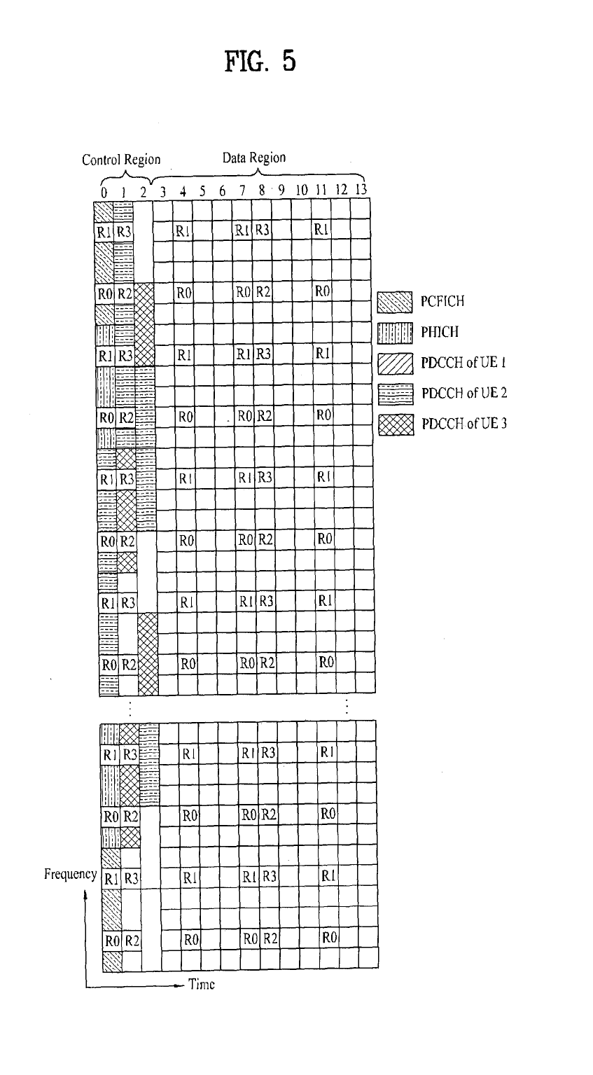

FIG. 5 illustrates an exemplary structure of a downlink radio frame that is used in the LTE system.

Referring to FIG. 5, one subframe is configured of 14 OFDM symbols. Depending upon the subframe settings, the first one to three OFDM symbols are used as the control region, and the remaining 13-11 OFDM symbols are used as the data region. Referring to the drawing, R1 to R4 respectively represent Reference Signals (RSs) or Pilot Signals for antennas 0 to 3. Regardless of the control region and the data region, the RS is fixed within the subframe according to a consistent pattern. A control channel is allocated to resources of the control region to which the RS is not allocated. And, a traffic channel is allocated to resources of the data region to which the RS is not allocated. Control channels that are allocated to the control region may include a PCFICH (Physical Control Format Indicator CHannel), a PHICH (Physical Hybrid-ARQ Indicator CHannel), a PDCCH (Physical Downlink Control CHannel), and so on.

As a Physical Control Format Indicator Channel, the PCFICH notifies the user equipment of the number of OFDM symbols used in the PDCCH for each subframe. The PCFICH is located in the first OFDM symbol and is configured at a higher priority level than the PHICH and the PDCCH. The PCFICH is configured of 4 REGs (Resource Element Groups), and each REG is distributed (or spread) within the control region based upon the Cell ID (Cell Identity). One REG is configured of 4 REs (Resource Elements). An RE represents a minimum physical resource defined by one subcarrier×one OFDM symbol. The PCFICH value indicates a value ranging from 1 to 3 or from 2 to 4 depending upon the bandwidth and is modulated by using QPSK (Quadrature Phase Shift Keying).

As a Physical HARQ (Hybrid-Automatic Repeat and request) Indicator Channel, the PHICH is used for delivering HARQ ACK/NACK respective to uplink transmission. More specifically, the PHICH represents a channel through which DL ACK/NACK information for UL HARQ is transmitted. The PHICH consists of one REG and is cell-specifically scrambled. An ACK/NACK is indicated by 1 bit and is modulated by using BPSK (Binary phase shift keying). The modulated ACK/NACK is distributed (or spread) by a Spreading Factor (SF)=2 or 4. A plurality of PHICH being mapped to the same resource configures a PHICH group. The number of PHICHs being multiplexed in the PHICH group is decided in accordance with the number of spreading codes. The PHICH (group) is repeated 3 times in order to obtain diversity gain in the frequency domain and/or the time domain.

As a Physical Downlink Control Channel, the PDCCH is allocated to the first n number of OFDM symbols of a subframe. Herein, n is an integer equal to or greater than 1, and n is designated by the PCFICH. The PDCCH is configured of one or more CCEs. The PDCCH notifies each user equipment or a user equipment group of information associated to resource allocation of a PCH (Paging Channel) and a DL-SCH (Downlink-shared channel), Uplink Scheduling Grant, HARQ information, and so on. The PCH (Paging Channel) and the DL-SCH (Downlink-shared channel) are transmitted through the PDSCH. Therefore, with the exception for specific control information or specific service data, the base station and the user equipment generally transmit and receive data through the PDSCH.

Information on the user equipment (one user equipment or a plurality of user equipments) to which the data of the PDSCH are to be transmitted, and information on how the user equipments receive and decode the transmitted PDSCH data are included in the PDCCH and transmitted. For example, it is assumed that a specific PDCCH is processed with CRC masking with an RNTI (Radio Network Temporary Identity) “A”, and it is also assumed that information on the data being transmitted by using a radio resource (e.g., frequency position) “B” and a transmission format information (e.g., transmission block size, modulation method, coding information, etc.) “C” are transmitted through a specific subframe. In this case, a user equipment within a cell uses its own RNTI so as to monitor the PDCCH. And, when one or more user equipments carries RNTI “A”, the corresponding user equipments receive the PDCCH and then receive the PDSCH, which is indicated by “B” and “C”, through the received PDCCH information.

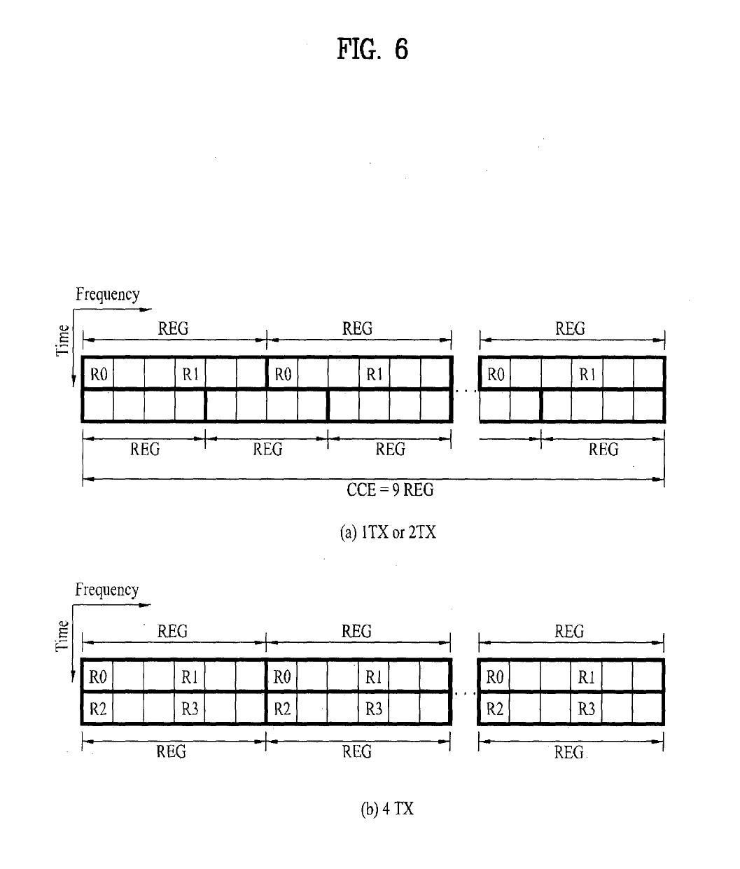

FIG. 6 illustrates a resource unit that is used for configuring a downlink control channel. More specifically, (a) of FIG. 6 illustrates a case where the number of transmission antennae within the base station is equal to 1 or 2, and (b) of FIG. 6 illustrates a case where the number of transmission antennae within the base station is equal to 4. Herein, only the RS (Reference Signal) pattern varies depending upon the number of transmission antennae. Otherwise, the method for configuring resource units in association with the control channel is the same.

Referring to FIG. 6, a basic resource unit of the control channel is an REG (Resource Element Group). Herein, while excluding the RS, the REG is configured of 4 resource elements (REs) adjacent to one another. In FIG. 6, the REG is marked by bold solid lining. The PDFICH and the PHICH respectively include 4 REGs and 3 REGs. The PDCCH s configured in CCE (Control Channel Element) units, wherein one CCE includes 9 REGs.

In order to verify whether or not a PDCCH being configured one L number of CCEs is being transmitted to the user equipment itself, the user equipment is configured to verify M^{(L)}(≧L) number of CCEs being consecutively aligned or aligned according to a specific alignment rule. The L value that should be considered by the user equipment for the PDCCH reception may correspond to a plurality of values. A group of CCEs that should be verified by the user equipment for the PDCCH reception is referred to as a search space. For example, the LTE system defines the search space as shown in Table 1 below.

TABLE 1

| | | | Number of | |
|---|---|---|---|---|
| Search space Sₖ^{(L)} | | | PDCCH | |
| | Aggregation | Size [in | candidates | |
| Type | level L | CCEs] | M^{(L)} | DCI formats |
| UE- | 1 | 6 | 6 | 0, 1, 1A, |
| specific | 2 | 12 | 6 | 2B, 1D, 2, |
| | 4 | 8 | 2 | 2A, 2B, 4 |
| | 8 | 16 | 2 | |
| Common | 4 | 16 | 4 | 0, 1A, 1C, |
| | 8 | 16 | 2 | 3/3A |

Herein, the CCE aggregation level L represents the number of CCEs configuring the PDDCH. Sₖ^{(L)} represents the search space of the CCE aggregation level L, and M^{(L)} represents the number of PCDDH candidates that are to be monitored in the search space of the aggregation level L.

The search space may be categorized as a UE-specific search space, which allows access only to specific user equipments, and a common search space, which allows the access of all user equipments existing within the corresponding cell. The user equipment monitors the common search spaces having the CCE aggregation levels 4 and 8 and also monitors UE-specific search spaces having the CCE aggregation levels 1, 2, 4, and 8. Herein, the common search space and the UE-specific search space may be overlapped.

Furthermore, in the PDCCH search space assigned to an arbitrary user equipment with respect to each CCE aggregation level value, the position of the first CCE (CCE having the lowest index) varies for each subframe in accordance with the user equipment. This is referred to as PDCCH search space hashing.

The CCE may be distributed (or spread) throughout the system bandwidth. More specifically, a plurality of logically consecutive CCEs may be inputted to an interleaver. And, the interleaver may perform a function of mixing (or interleaving) the plurality of inputted CCEs in REG units. Accordingly, the frequency/time resource configuring one CCE is physically spread throughout the entire frequency/time domain within the control region of the subframe, thereby being distributed. Eventually, although the control channel is configured in CCE units, by performing the interleaving process in REG units, frequency diversity and interference randomization may be maximized.

FIG. 7 illustrates an exemplary structure of an uplink subframe that is used in the LTE system.

Referring to FIG. 7, an uplink subframe may be divided into a region having a PUCCH (Physical Uplink Control CHannel) carrying control information allocated thereto, and a region having a PUSCH (Physical Uplink Shared CHannel) carrying user data allocated thereto. A middle portion of the subframe is allocated to the PUSCH, and both end portions of the data region within the frequency domain are allocated to the PUCCH. The control information that is transmitted over the PUCCH includes an ACK/NACK being used for the HARQ, a CQI (Channel Quality Indicator) indicating a downlink channel status, an RI (Rank Indicator) for MIMO, an SR (Scheduling Request) corresponding to an uplink resource allocation request, and so on. The PUCCH for one user equipment uses one resource block, which occupies a different frequency for each slot within the subframe. More specifically, 2 resource blocks being allocated to the PUCCH are frequency hopped at a slot boundary. Most particularly, FIG. 6 shows an example of a PUCCH wherein m=0, a PUCCH wherein m=1, a PUCCH wherein m=2, and a PUCCH wherein m=3 are allocated to the subframe.

Meanwhile, if the channel status between the base station and the user equipment is poor, (or deficient), a Relay Node (RN) may be installed, so that a radio channel having a more enhanced channel status can be provided to the user equipment. Also, by adopting and using a relay node from the base station in a cell boundary region having a poor channel status, a data channel having a faster rate may be provided, and a cell service region may be extended. As described above, the relay node, which is currently most broadly used, corresponds to a technology that is adopted to resolve radio shadow areas within the wireless (or radio) communication system.

As opposed to the precedent methods, which were limited to the functions of a repeater transmitting signals by simply amplifying the signals, the recent methods have been evolving to a more intelligent form. Furthermore, the relay node technology corresponds to a technology that is required for reducing costs for additional base station installation and costs for maintaining a backhaul network within the next generation mobile communication system, and that is, at the same time, required for extending service coverage and enhancing the data processing rate. As the relay node technology is gradually being developed, the relay node that is used in the related art wireless communication system is required to be supported by the new mobile communication system.

In the 3GPP LTE-A (3rd Generation Partnership Project Long Term Evolution-Advanced) system, by adopting the function of forwarding a link access (or link connection) between the base station and the user equipment to the relay node, two types of links, each having a different property, may be applied to each of the uplink and downlink carrier frequency bands. An access link portion configured between the links of the base station and the relay node is defined and expressed as a backhaul link. And, a transmission that is realized in an FDD (Frequency Division Duplex) or TDD (Time Division Duplex) method by using a downlink resource may be referred to as a backhaul downlink, and a transmission that is realized in an FDD (Frequency Division Duplex) or TDD (Time Division Duplex) method by using an uplink resource may be referred to as a backhaul uplink.

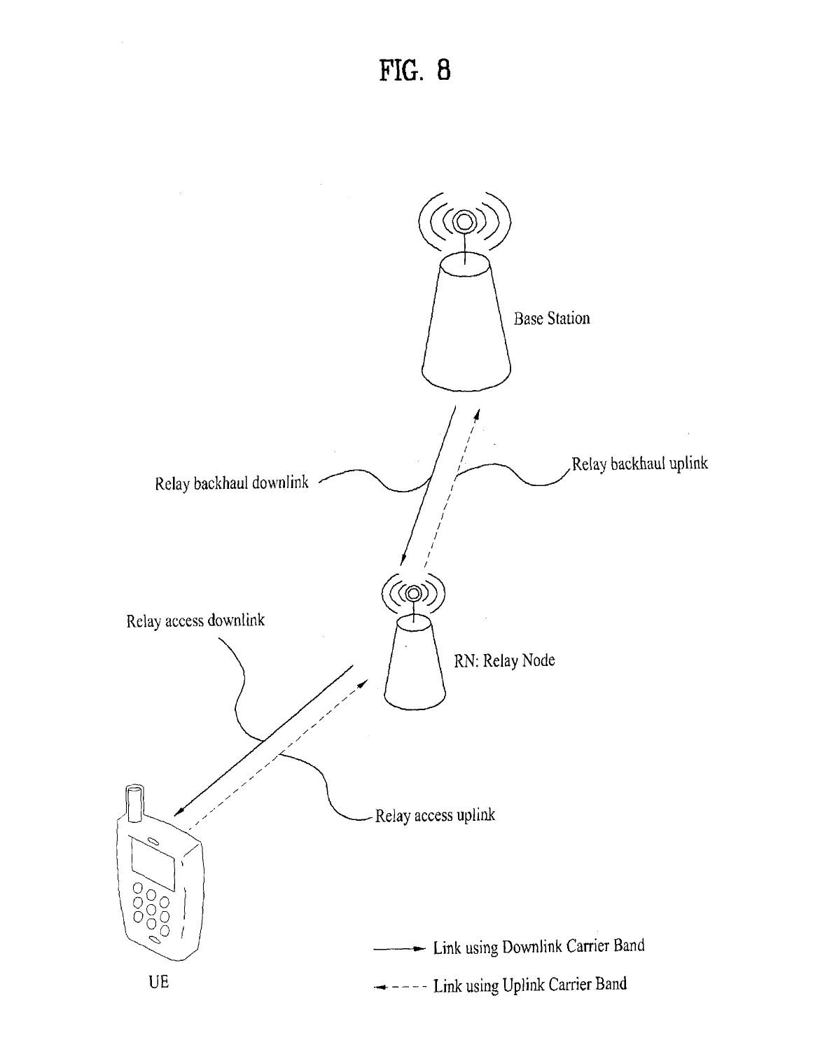

FIG. 8 illustrates structures of a relay backhaul link and a relay access link in a wireless communication system.

Referring to FIG. 8, as the relay node is adopted for the function of forwarding a link access (or link connection) between the base station and the user equipment, two types of links, each having a different property, may be applied to each of the uplink and downlink carrier frequency bands. Herein, an access link portion configured between the links of the base station and the relay node is defined and expressed as a relay backhaul link. When transmission of the backhaul link is realized by using a downlink frequency band (in case of the Frequency Division Duplex (FDD)) or a downlink subframe (in case of the Time Division Duplex (TDD)) resource, the backhaul link may be referred to as a backhaul downlink, and when transmission of the backhaul link is realized by using an uplink frequency band (in case of the FDD) or an uplink subframe (in case of the TDD) resource, the backhaul link may be referred to as a backhaul uplink.

On the other hand, an access link portion configured between the relay node and a series of user equipments is defined and expressed as a relay access link. When transmission of the relay access link is realized by using a downlink frequency band (in case of the FDD) or a downlink subframe (in case of the TDD) resource, the relay access link may be referred to as an access downlink, and when transmission of the relay access link is realized by using an uplink frequency band (in case of the FDD) or a downlink subframe (in case of the TDD) resource, the relay access link may be referred to as an access uplink.

The relay node (RN) may receive information from the base station via relay backhaul downlink and may transmit information to the base station via relay backhaul uplink. Also, the relay node may transmit information to the user equipment via relay access downlink and may received information from the user equipment via relay access uplink.

Meanwhile, in association with the usage of a band (or spectrum) of the relay node, an ‘in-band’ refers to a case where the backhaul link operates in the same frequency band as the access link, and an ‘out-band’ refers to a case where the backhaul link operates in a same frequency band different from that of the access link. In both in-band and out-band, the user equipment (hereinafter referred to as a legacy user equipment) that operates in accordance with the conventional LTE system (e.g., Release-8) should be capable of accessing a donor cell.

Depending upon whether or not the user equipment recognizes the relay node, the relay node may be categorized as a transparent relay node or a non-transparent relay node. The relay node is determined as being transparent, when it is difficult to recognize whether or not the user equipment is communicating with the network through the relay node, and the relay node is determined as being non-transparent, when it is recognized that the user equipment is communicating with the network through the relay node

In relation with the control of the relay node, the relay node may be identified as a relay node being configured as a portion of the donor cell or as a relay node controlling the cell by itself.

The relay node being configured as a portion of the donor cell may have a relay node identifier (ID). However, in this case, the relay node does not have its own cell identity. When at least a portion of an RRM (Radio Resource Management) is controlled by the base station to which the corresponding cell belongs (even if the remaining portions of the RRM are located in the relay node), the relay node is referred to as a relay node being configured as a portion of the donor cell. Preferably, such relay node may support the legacy user equipment. For example, diverse types of relay nodes, such as Smart repeaters, decode-and-forward relays, L2 (second layer) relay nodes, and Type-2 relay nodes correspond to such relay node.

In case of the relay node controlling the cell by itself, the relay node may control one cell or multiple cells, and the cell being controlled by the relay node may each be provided with a unique physical layer cell identity, and the same RRM mechanism may be used. In the perspective of the user equipment, there is no difference between accessing a cell that is being controlled by the relay node and accessing a cell that is being controlled by a general base station. Preferably, the cell that is being controlled by such relay node may support the legacy user equipment. For example, Self-backhauling relay nodes, L3 (third layer) relay nodes, Type-1 relay nodes, and Type-1a relay nodes may correspond to such relay node.

As an in-band relay node, the Type-1 relay node controls a plurality of cells, and each of the plurality of cell may be viewed by the user equipment as separate cells being differentiated from the donor cell. Also, each of the plurality of cells has its own physical cell ID (defined in LTE Release-8), and the relay node may transmits its synchronization channel, reference signal, and so on. In case of a single-cell operation, the user equipment may directly receive scheduling information and HARQ feedback from the relay node and may transmit its control channel (scheduling request (SR), CQI, ACK/NACK, etc.) to the relay node. Also, the Type-1 relay node may be viewed as a legacy base station (base station operating in accordance with the LTE Release-8 system) by the legacy user equipments (user equipments operating in accordance with the LTE Release-8 system). More specifically, backward compatibility is provided. Meanwhile, for the user equipments operating in accordance with the LTE-A system, the Type-1 relay node may be viewed as a base station other than the legacy base station. Thus, performance may be enhanced.

With the exception for operating as an out-band relay node, the Type-1a relay node has the same features and characteristics as the above-described Type-1 relay node. The operations of Type-1a relay node may be configured so that influence caused by the operations of L1 (first layer) can be minimized or eliminated.

As an in-band relay node, the Type-2 relay node does not have a separate physical cell ID and, accordingly, the Type-2 relay node does not create (or configure) a new cell. The Type-2 relay node corresponds to a transparent relay node for the legacy user equipment, and the legacy user equipment is incapable of recognizing the existence of the Type-2 relay node. The Type-2 relay node may transmit the PDSCH but does not transmit at least the CRS and the PDCCH.

Meanwhile, in order to enable the relay node to operate as an in-band relay node, a portion of the resource corresponding to the time-frequency domain should be reserved for a backhaul link, and this resource may be configured so that the corresponding resource cannot to be used for an access link. This is referred to as resource partitioning.

The general principle of resource partitioning in a relay node may be described as follows. A backhaul downlink and an access downlink may be multiplexed within a single carrier frequency by using a Time Division Multiplexing (TDM) scheme (i.e., only one of the backhaul downlink and the access downlink is activated at a specific time). Similarly, a backhaul uplink and an access uplink may be multiplexed within a single carrier frequency by using a TDM scheme (i.e., only one of the backhaul uplink and the access uplink is activated at a specific time).

Backhaul link multiplexing in the FDD may be described that a backhaul downlink transmission is performed in a downlink frequency band, and that a backhaul uplink transmission is performed in an uplink frequency band. Backhaul link multiplexing in the TDD may be described that a backhaul downlink transmission is performed in a downlink subframe of the base station and the relay node, and that a backhaul uplink transmission is performed in an uplink subframe of the base station and the relay node.

In case of the in-band relay node, for example, when a backhaul downlink reception from the base station and an access downlink transmission to the user equipment are realized at the same time in a predetermined frequency band, a signal being transmitted from a transmitting end of the relay node may be received by a receiving end of the relay node. And, accordingly, signal interference or RF jamming may occur in an RF front-end of the relay node. Similarly, when an access uplink reception from the user equipment and a backhaul uplink transmission to the base station are realized at the same time in a predetermined frequency band, a signal interference may occur in an RF front-end of the relay node. Therefore, in the relay node, if sufficient partitioning (e.g., installing a transmitting antenna and a receiving antenna by sufficiently spacing them apart geographically (e.g., above the ground level/underground)) between the receiving signal and the transmitting signal fails to be provided, it will be difficult to realize a simultaneous reception and transmission within a frequency band.

One of the methods for resolving such problem of signal interference is to configure the operations so that the relay node does not transmit a signal to the user equipment, while the relay node receives a signal from the donor cell. More specifically, a gap period is formed in the transmission from the relay node to the user equipment. And, the user equipment (including the legacy user equipment) may be configured to not expect any kind of transmission from the relay node during the gap period. This gap period may be set up by configuring an MBSFN (Multicast Broadcast Single Frequency Network) subframe.

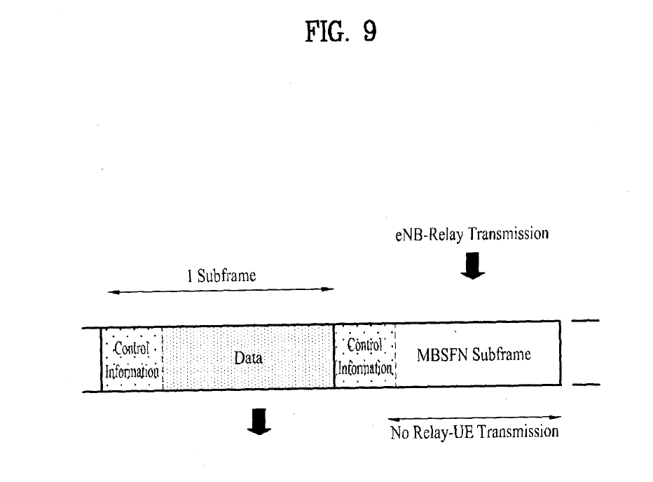

FIG. 9 illustrates an exemplary relay node resource division.

In FIG. 9, a first subframe corresponds to a general subframe, wherein a downlink (i.e., access downlink) control signal and data are transmitted from the relay station to the user equipment. And, a second subframe corresponds to an MBSFN subframe, wherein a control signal is transmitted from the relay node to the user equipment in the control region of the downlink subframe, and wherein no transmission is performed from the relay node to the user equipment in the remaining regions of the downlink subframe. Herein, in case of the legacy user equipment, since the transmission of a downlink physical layer channel (PDCCH) is expected in all downlink subframes (in other words, since the relay node is required to support the legacy user equipments within the regions of the relay node itself, so that the corresponding legacy user equipments can receive the PDCCH in each subframe and perform measurement functions), in order to allow the legacy user equipment to perform the correct operations, the PDCCH is required to be transmitted from all downlink subframes. Therefore, in a subframe (second subframe), which is configured to perform downlink (i.e., backhaul downlink) transmission from the base station to the relay node, in the first N number of OFDM symbol sections (wherein N=1, 2, or 3) of the subframe, instead of receiving a backhaul downlink, the relay node is required to perform access downlink transmission. Respectively, since the PDCCH is transmitted from the relay node to the user equipment in the control region of the second subframe, backward compatibility for a legacy user equipment, which is served by the relay node, may be provided. In the remaining regions of the second subframe, while no transmission is performed from the relay node to the user equipment, the relay node may receive transmission from the base station. Therefore, by using such resource partitioning method, access downlink transmission and backhaul downlink reception may not be performed simultaneously in the in-band relay node.

A second subframe using an MBSFN subframe will now be described in detail. The control region of the second subframe may be referred to as a relay node non-hearing section. The relay node non-hearing section refers to a section that does not receive backhaul downlink signal and that transmits an access downlink signal. As described above, this section may be configured to have the length of 1, 2, or 3 OFDM. In the relay node non-hearing section, the relay node may perform access downlink transmission to the user equipment, and, in the remaining regions, the relay node may receive backhaul downlink from the base station. At this point, since the relay node cannot simultaneously perform transmission and reception in the same frequency band, a considerable amount of time is required for the relay node to switch from the transmission mode to the reception mode. Therefore, a guard time (GT) is required to be set up so that the relay node can switch to and from the transmission/reception modes, during the first partial section of the backhaul downlink reception region. Similarly, even when the relay node is operated to receive a backhaul downlink from the base station and to transmit an access downlink to the user equipment, a guard time (GT) is required to be set up so that the relay node can switch to and from the transmission/reception modes. A time domain value may be given as the length of such guard time, for example, k (k≧1) number of time sample (Ts) may be given as the length of the guard time, or at least one OFDM symbol length may be given as the guard time length. Alternatively, in case relay node backhaul downlink subframes are consecutively configured, or depending upon a predetermined subframe timing alignment relation, the guard time of the last portion of the subframe may not be defined nor configured. In order to maintain such backward compatibility, the guard time may be defined only in the frequency domain, which is configured for backhaul downlink subframe transmission (in case the guard time is configured in an access downlink section, the legacy user equipment cannot be supported). In the backhaul downlink reception section excluding the guard time, the relay node may receive the PDCCH and the PDSCH from the base station. As relay node specific physical channels, such channels may also be referred to as an R-PDCCH (Relay-PDCCH) and an R-PDSCH (Relay-PDSCH).

In the current wireless communication environment, due to the advent and supply of diverse types of devices requiring M2M (Machine-to-Machine) communication and high data transmission amount, the amount of data requirement is increasing at a very fast rate. In order to meet with the high required data capacity, eventually, a carrier aggregation technique, which is established to efficiently use a larger number of frequency bands, a multiple antenna technique, which is established to increase the data capacity within a limited frequency, a multiple base station cooperation technique, and so on, are developed in the communication technology. And, the communication environment may gradually evolve to an environment with increased node density that can access the surroundings of the user. A system being provided with such high density node may demonstrate greater system performance based upon the cooperation between the nodes existing in the corresponding system. Such method demonstrates a more enhanced performance as compared to when each node performs as an independent base station (Base Station (BS), Advanced BS (ABS), Node-B (NB), eNode-B (eNB), Access Point (AP), and so on).

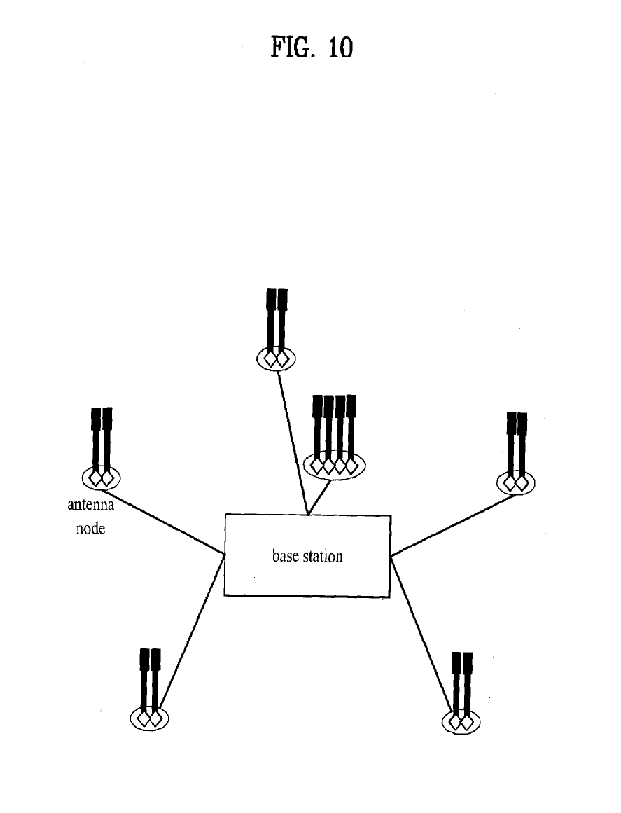

FIG. 10 illustrates an example of a multiple node system in a next generation communication system.

Referring to FIG. 10, when the transmission and reception of all of the existing nodes are managed by a single controller, and, therefore, when an individual cell operates as a selected antenna or antenna group of a single cell, this system may be considered as a distributed multi node system (DMNS), which configures a single cell. At this point, each individual node may be assigned with a separate Node ID, and each node may also operate as a partial antenna within the corresponding cell without using the separate Node ID. However, when the nodes are provided with different Cell Identifiers (IDs), this may indicate that the system corresponds to a multiple cell system. When such multiple cells are configured in an overlaying format in accordance with the coverage, this may be referred to as a multi-tier network.

Meanwhile, NodeB, eNodeB, PeNB, HeNB, RRH (Remote Radio Head), relay and distribution antennae, and so on may correspond to the node. And, at least one antenna is installed in each node. The node may also be referred to as a Transmission Point. A node generally refers to an antenna group having the antennae spaced from one another at constant intervals. However, in the description of the present invention, the present invention may apply a node, which is defined as an arbitrary antenna group being arranged regardless of the interval.

By adopting the above-described multi node system and relay node, diverse communication methods maybe available, thereby enhancing the channel quality. However, in order to apply the above-described MIMO method and inter-cell cooperation communication method in the multi node environment, the adoption of a new type of control channel is being required. E-PDDCH (Enhanced-PDCCH) has been decided as the control channel currently being newly mentioned to be applied to the multi node environment, in order to meet with the above-described requirements. And, it has also been decided that the E-PDCCH is to be allocated to a data region (hereinafter referred to as the PDSCH region) instead of the conventional control region (hereinafter referred to as the PDSCH region). In conclusion, the control information respective to each node may be transmitted to each respective user equipment through such E-PDCCH, thereby resolving the problem of any possible lack of the conventional PDCCH region. Herein, the E-PDCCH is not provided to the conventional legacy user equipment, and only the LTE-A user equipment may′ be capable of receiving the E-PDCCH.

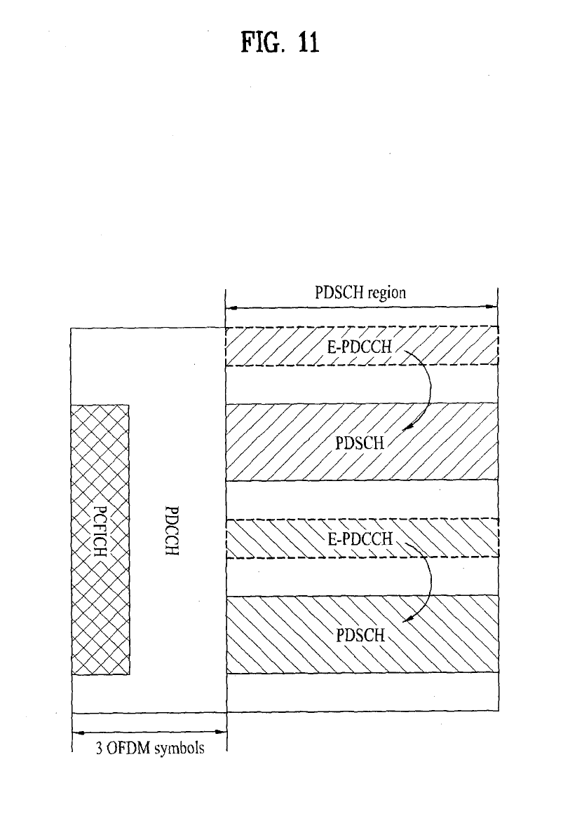

FIG. 11 illustrates an exemplary E-PDCCH and an exemplary PDSCH, which is being scheduled by the E-PDDCH.

Referring to FIG. 11, the E-PDCCH may be defined and used as a portion of the PDSCH region, which generally transmits data. And, the user equipment is required to perform a blind decoding procedure in order to detect the presence or absence of its E-PDCCH. Although the E-PDCCH performs the same scheduling operations (i.e., PDSCH, PUSCH control) as the conventional PDCCH, when the number of user equipment accessing a node, such as the RRH, increases, a larger number of E-PDCCHs is allocated to the PDSCH region, thereby causing an increase in the number of blind decoding procedures that are to be performed by the user equipment. This may lead to a disadvantage of increasing the degree of complexity in the user equipment.

Meanwhile, a more detailed allocation method of the E-PDCCH may correspond to an access method that seeks to re-use the conventional R-PDCCH structure.

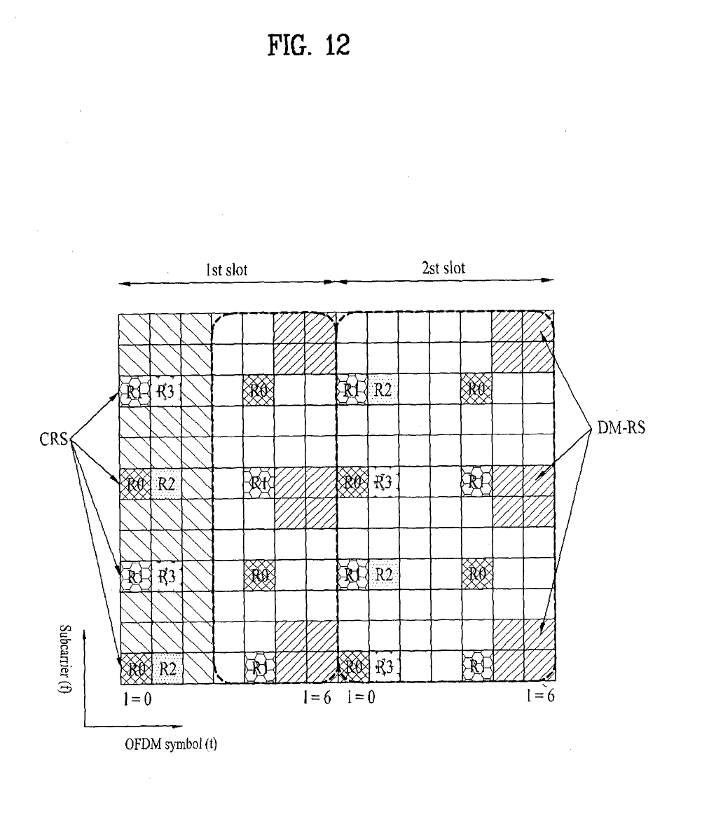

FIG. 12 illustrates an exemplary structure of an R-PDCCH being transmitted to a relay node.

Referring to FIG. 12, only a DL grant is allocated to a 1st slot, and a UL grant or data PDSCH may also allocated to a 2nd slot. At this point, the R-PDCCH is allocated to all data RE, with the exception for the PDCCH region, CRS, and DMRS. Herein, the DM-RS and the CRS may both be used for the R-PDCCH demodulation. And, when using the DM-RS, Port 7 and Scrambling ID (SCID)=0 are used.

Alternatively, when using the CRS, Port 0 is used only when the number of PBCH transmission antenna is equal to 1. When the number of PBCH transmission antennae is equal to 2 and 4, the operation mode is shifted to the transmission diversity mode, thereby enabling both Port 0-1 and Port 0-3 to be used.

In the detailed allocation of the E-PDCCH, the re-usage of the conventional R-PDCCH structure eventually signifies that the DL grant and the UL grant are separately allocated to each slot. In the description of the present invention, this allocation method will be referred to as related art 1).

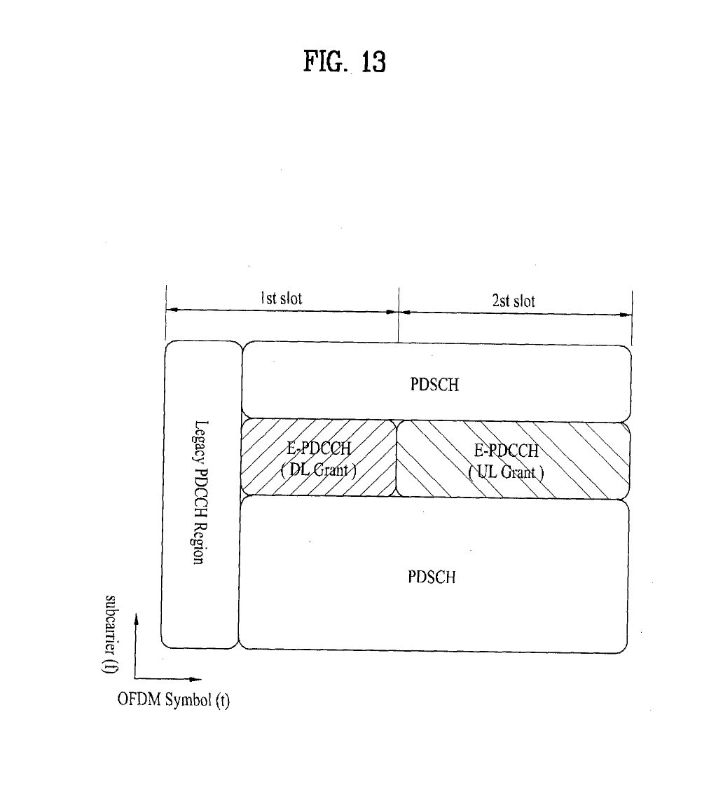

FIG. 13 illustrates an example of allocating (or assigning) an E-PDCCH in accordance with a related art 1).

According to related art 1), when allocating the E-PDCCH, the DL grant is allocated to the first slot of the subframe, and the UL grant is allocated to the second slot of the subframe. Herein, it will be assumed that the E-PDCCH is configured in both the first slot and the second slot of the subframe. At this point, the DL grant is separately allocated to the E-PDCCH of the first slot, and the UL grant is separately allocated to the E-PDCCH of the second slot.

Since the DL grant and the UL grant, which are to be searched by the user equipment for each slot within the subframe, are separately allocated, the user equipment configures a search region within the first slot, so as to perform a blind decoding procedure for locating the DL grant, and the user equipment performs a blind decoding procedure for locating the UL grant from the search region configured in the second slot.

Meanwhile, a Downlink Transmission Mode (DL TM) and an Uplink Transmission Mode (UL TM) exist in the current 3GPP LTE system. And, 1 TM is configured for each user equipment through higher layer signaling. In the DL TM, 2 formats of the downlink control information, i.e., 2 DCI formats that should be found by each user equipment exist for each configured mode. Conversely, in the UL TM, 1 DCI format or 2 DCI formats that should be found by each user equipment exist for each configured mode. For example, the downlink control information corresponding to the UL grant corresponds to DCI format 0, which exists in UL TM 1, and the downlink control information corresponding to the UL grant corresponds to DCI format 0 and DCI format 4, which exist in UL TM 2. Herein, the DL TM is defined from mode 1 to mode 9, and the UL TM is defined as one of mode 1 and mode 2.

Accordingly, as shown in FIG. 13, the number of blind decoding procedures that are to be performed for each of the DL grant and UL grant allocation regions, in order to locate the E-PDCCH of the corresponding user equipment itself, from the user equipment specific search region for each slot is as shown below.

(1) DL Grant=(number of PDCCH candidates)×(number of DCI formats in configured DL TM)=16×2=32

(2) UL Grant of UL TM 1=(number of PDCCH candidates)×(number of DCI formats in UL TM 1)=16×1=16

(3) UL Grant of UL TM 2=(number of PDCCH candidates)×(number of DCI formats in UL TM 2)=16×2=32

(4) Total Number of Blind Decoding procedures=Number of Blind Decoding procedures in First Slot+Number of Blind Decoding procedures in Second Slot
UL TM 1: 32+16=48 times
UL TM 2: 32+32=6.4 times

Meanwhile, a method for simultaneously allocating the DL grant and the UL grant in the first slot has also been proposed. This will be referred to as related art 2) for simplicity.

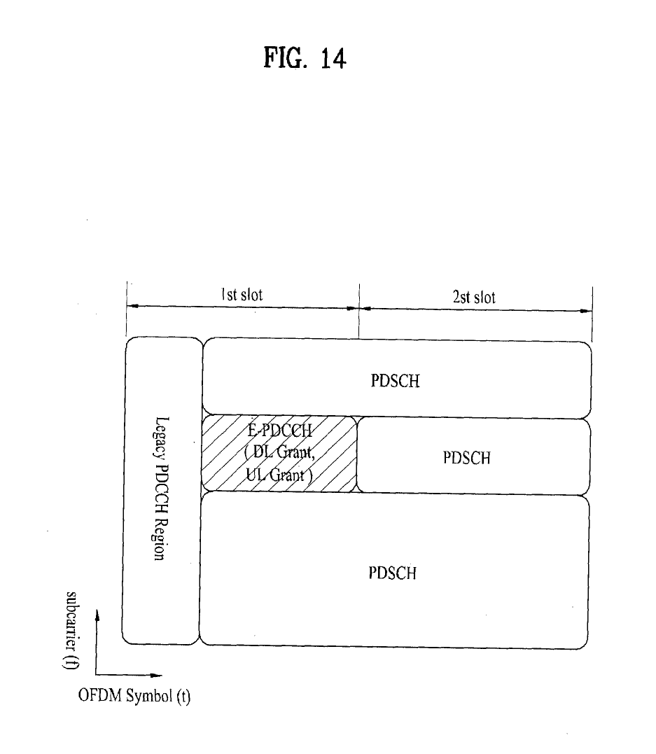

FIG. 14 illustrates an example of allocating (or assigning) an E-PDCCH in accordance with a related art 2).

Referring to FIG. 14, when allocating the E-PDCCH, the DL grant and the UL grant are simultaneously allocated to the first slot of the subframe. Most particularly, in FIG. 14, Herein, it will be assumed that the E-PDCCH is configured only in the first slot of the subframe. Therefore, the DL grant and the UL grant may simultaneously exist in the E-PDCCH of the first slot, and the user equipment may perform the blind decoding procedure for locating the DL grant and the UL grant only from the first slot of the subframe.

As described above, in the 3GPP LTE system, the DCI format that should be located (searched and found) is decided based upon the TM configured for each user equipment. Most particularly, a total of 2 DCI formats, i.e., DL grants are decided for each of the DL TM. And, DCI format 1A, which is configured for supporting a fall-back mode, is essentially included in each DL TM. Among the UL grants, since DCI format Q has the same length as DCI format 1A, and since DCI format 0 may be identified by a 1 bit flag, additional blind decoding is not required to be performed. However, among the UL grants, the remaining one UL grant, DCI format 4 is required to perform additional blind decoding.

Therefore, an overall blind decoding procedure identical to that of the conventional legacy PDCCH region is performed. And, the number of blind decoding procedures that are to be performed in order to search and find the R-PDCCH in the user equipment specific region, i.e., in order to locate the DL grant and the UL grant, is as shown below.

(1) DL Grant=(number of PDCCH candidates)×(number of DCI formats in configured DL TM)=16×2=32

(2) UL Grant of UL TM 1=(number of PDCCH candidates)×(number of DCI formats in UL TM 1)=0

(3) UL Grant of UL TM 2=(number of PDCCH candidates)×(number of DCI formats in UL TM 2)=16×1=16

(4) Total Number of Blind Decoding procedures
UL TM 1: 32+0=32 times
UL TM 2: 32+16=48 times

Meanwhile, the E-PDCCH designated for multiple users may essentially be multiplexed by using the spatial multiplexing method. Alternatively, other than the above-described multiplexing method, the description of the present invention proposes a method enabling the E-PDCCH, which is designated for multiple users, to gain maximum frequency diversity and to be multiplexed at the same time. Accordingly, it will be assumed that the allocated E-PDCCH region is shared by multiple user equipments, and that PRBs (Physical Resource Blocks), to which the E-PDCCH is being allocated, are continuously aligned in the frequency domain or uniformly aligned within the entire band.

### First Embodiment

In the first embodiment of the present invention, a method for multiplexing the E-PDCCH of multiple user equipments by dividing the CCE of the E-PDCCH, which is being allocated to one or more PRBs, into symbol units and allocating the divided CCE will be proposed. More specifically, when multiple RBs, to which the E-PDCCH is allocated, are shared by multiple user equipments, the E-PDCCH may be divided into symbol units respective to the time axis, so as to be allocated to the user equipment, thereby being multiplexed.

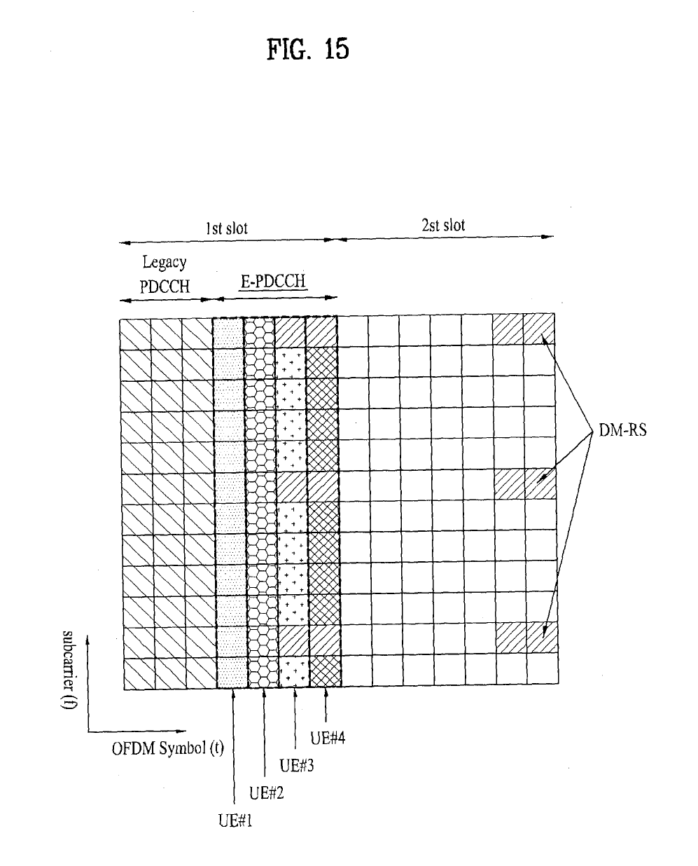

FIG. 15 illustrates an example of an E-PDCCH, which is multiplexed in accordance with a first exemplary embodiment of the present invention.

Referring to FIG. 15, the E-PDCCH of 4 user equipments is allocated in symbol units, and the E-PDCCH may be extended by using the same method with respect to multiple RBs. Such symbol-unit E-PDCCH allocation may be performed based upon the following factors.

One is channel estimation. In order to perform channel estimation respective to the E-PDCCH, a DM-RS port may be allocated for each user equipment.

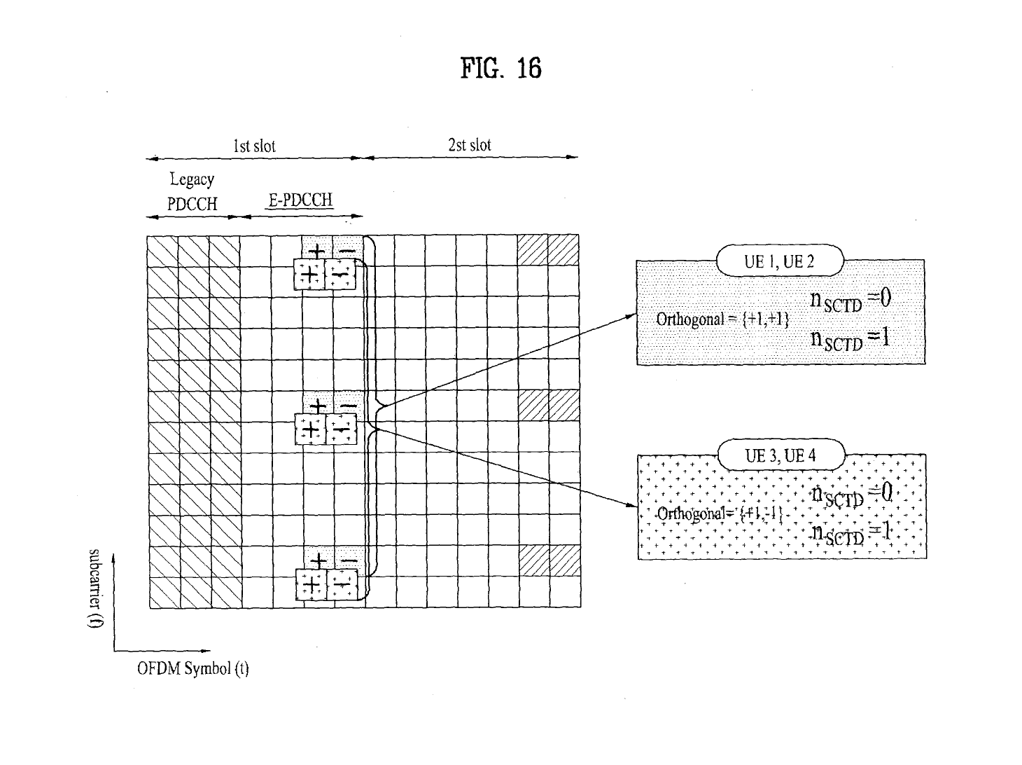

FIG. 16 illustrates an example of allocating (or assigning) a DM-RS port for each user equipment, in order to multiplex the E-PDCCH in accordance with the first exemplary embodiment of the present invention.

In order to perform E-PDCCH decoding as shown in FIG. 16, a maximum of 4 user equipments should each be capable of performing channel estimation by using the 6 DM-RS symbols existing in the 1^{st} slot. At this point, the 2 DM-RS symbols which are adjacent to one another along the time axis may be divided into 2 ports, such as Group 1, which is configured of UE 1 and UE 2, and Group 2, which is configured of UE 3 and UE 4, by using a code division multiplexing (CDM) method. Additionally, 2 ports may be additionally allocated to symbols being allocated along the frequency axis within each group by using a quasi-orthogonal sequence.

Actually, in the conventional LTE system, when allocating the DM-RS, since quasi-orthogonal DM-RS allocation may be performed by multiplexing the DM-RS along the time axis by using an orthogonal code, and by setting up n_{SCID} to 0 or 1, the method proposed in the description of the present invention may also use the same process without any modification.

Equation 8 shown below corresponds to an equation for generating a DM-RS sequence in the LTE system. Herein, since n_{SCID}=n_{RNIT}/={0,1}, a quasi-orthogonal pseudo-random sequence may be generated.

$${r}_{{n}_{s}} = ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) ) , \\ m = 0 , 1 , ⋯ , 12 {N}_{RB}^{PDSCH} - 1 \\ {C}_{init} = ( ⌊ {n}_{s} / 2 ⌋ + 1 ) \cdot ( 2 {N}_{ID}^{cell} + 1 ) \cdot {2}^{16} + {n}_{RNTI} \qquad [ Equation 8 ]$$

The second factor that should be considered for the symbol-unit E-PDCCH allocation is the adjustment of the number of resource elements (REs), which configure the CCE. Generally, the allocation of the E-PDCCH may be performed by using rate-matching regardless of the number of REs that can be used for each user equipment. For example, by using rate matching, a CCE may be configured so that 12 REs can be used in each of the RBs allocated to UE 1 and UE 2, and another CCE may be configured so that 9 REs can be used in each of the RBs allocated to UE 3 and UE 4.

In the current 3GPP standardization convention, a compact DCI, which is configured of a number of bits smaller than the number of bits configuring the DCI (Downlink Control Information) format, which corresponds to the conventional downlink control information, is being under research. If such compact DCI is allocated to the symbol region, which can use a relatively smaller number of REs, reliability equivalent to the E-PDCCH of other user equipments may be ensured.

The above-described method may also be extended to the 2^{nd} slot by using the same method.

### Second Embodiment

In the second embodiment of the present invention, a method for multiplexing the E-PDCCH of multiple user equipments by dividing the CCE of the E-PDCCH, which is being allocated to one or more PRBs, to a frequency band within the PRB and allocating the divided CCE will be proposed. More specifically, when multiple RBs, to which the E-PDCCH is allocated, are shared by multiple user equipments, the E-PDCCH may be divided into symbol units respective to the frequency axis, so as to be allocated to the user equipment, thereby being multiplexed.

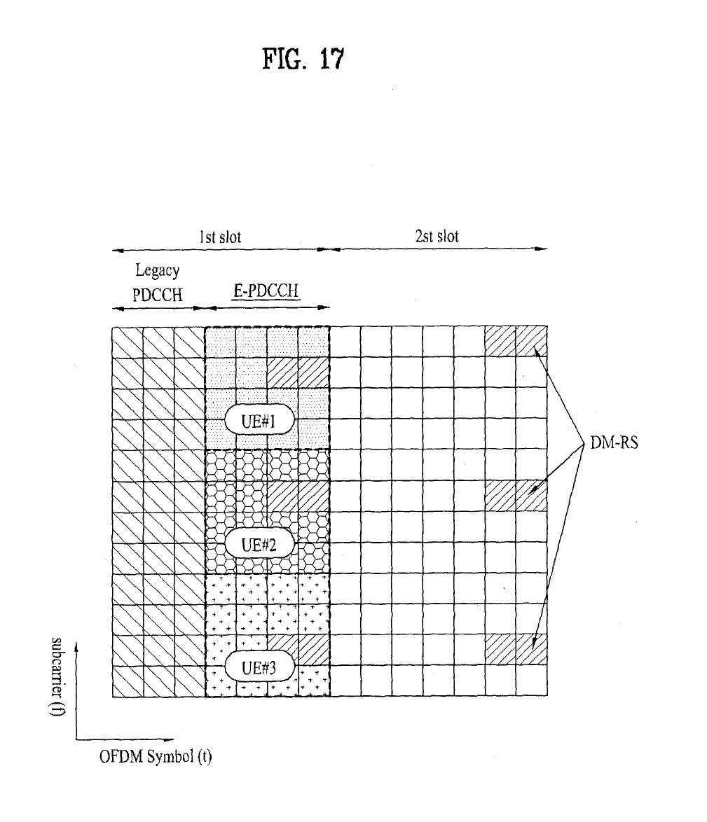

FIG. 17 illustrates an example of an E-PDCCH, which is multiplexed in accordance with a second exemplary embodiment of the present invention.

Referring to FIG. 17, it may be known that an E-PDCCH for 3 user equipments has been multiplexed to 4 subcarrier aggregation units within a single RB. And, at this point, extension may be made for multiple RBs by using the same method.

As described in the first embodiment, the E-PDCCH allocation using the frequency division multiplexing method according to the second embodiment of the present invention should also consider channel estimation and the number of REs configuring the CCE.

First of all, channel estimation will be described. In order to perform channel estimation respective to the E-PDCCH, an antenna port for the DM-RS may be allocated for each user equipment. However, according to the second embodiment of the present invention, since the DM-RS, which is allocated to the RB for the multiplexed E-PDCCH, may also be divided with respect to each user equipment, a more flexible application method is required.

For example, as shown in FIG. 17, in order to perform E-PDCCH decoding, a maximum of 3 user equipments should each be capable of performing channel estimation by using the 6 DM-RS symbols existing in the 1^{st} slot. At this point, channel estimation may be performed for each user equipment by using the 2 DM-RS symbols, which are adjacent to one another along the time axis. In this case, the size of the subcarrier aggregation being assigned to each user equipment may be flexibly adjusted for each user equipment. And, in case 2 user equipments are multiplexed, when performing channel estimation DM-RS REs may be additionally used for the user equipments, which are allocated with a larger number of REs.

Subsequently, with respect to the number of REs configuring the CCE, identical number of REs may be allocated to each user equipment, or REs may be additionally allocated to a specific user equipment so that a larger number of REs can be used. FIG. 17 illustrates an example of allocating the same number of REs that can be used for each user equipment. And, in this case, the CCE size of the E-PDCCH is also the same for each user equipment.

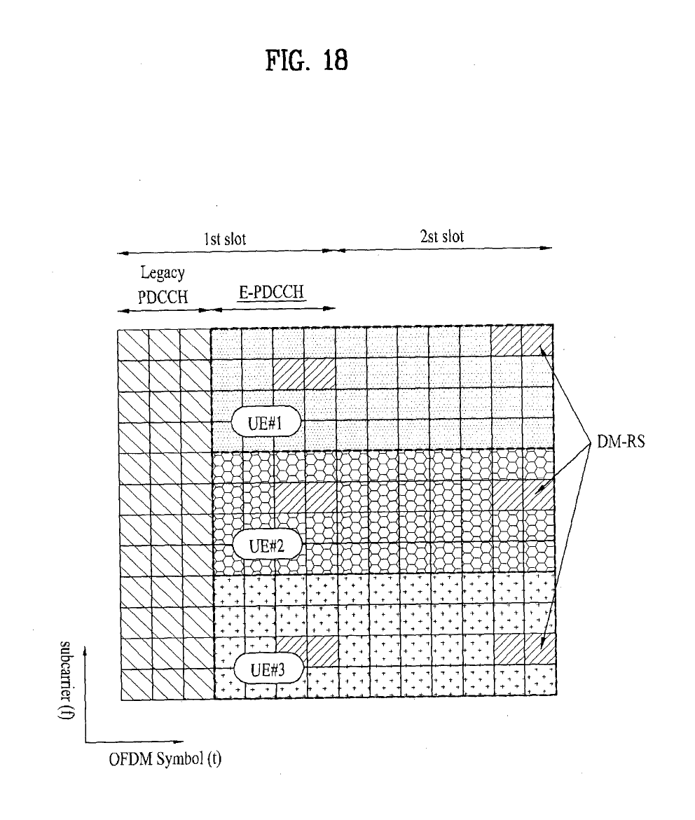

The above-described method may also be extended to the 2^{nd} slot by using the same method, as shown in FIG. 18.

### Third Embodiment

The third embodiment of the present invention proposes a method of multiplexing the E-PDCCH by alternating a PRB pair including both the 1^{st} slot and the 2^{nd} slot in a single subcarrier unit or multiple subcarrier units.

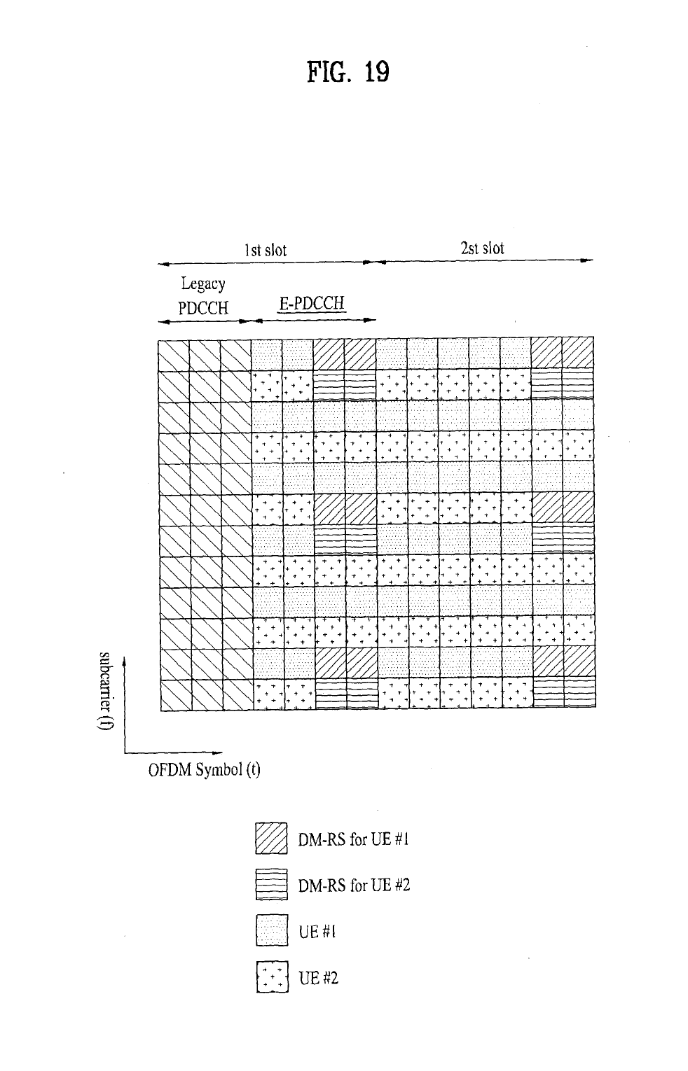

FIG. 19 illustrates an example of an E-PDCCH, which is multiplexed in accordance with a third exemplary embodiment of the present invention. Most particularly, FIG. 19 shows an example of the multiplexed E-PDCCH for 2 user equipments.

By using the above-described method, the E-PDCCH allocation process may be performed within the entire RB in the same CCE size. And, at the same time, the above-described method may support channel estimation of the user equipment by performing antenna port allocation for an adequate DM-RS. Most particularly, FIG. 19 shows a case when different DM-RS REs are allocated for each user equipment in order to perform channel estimation.

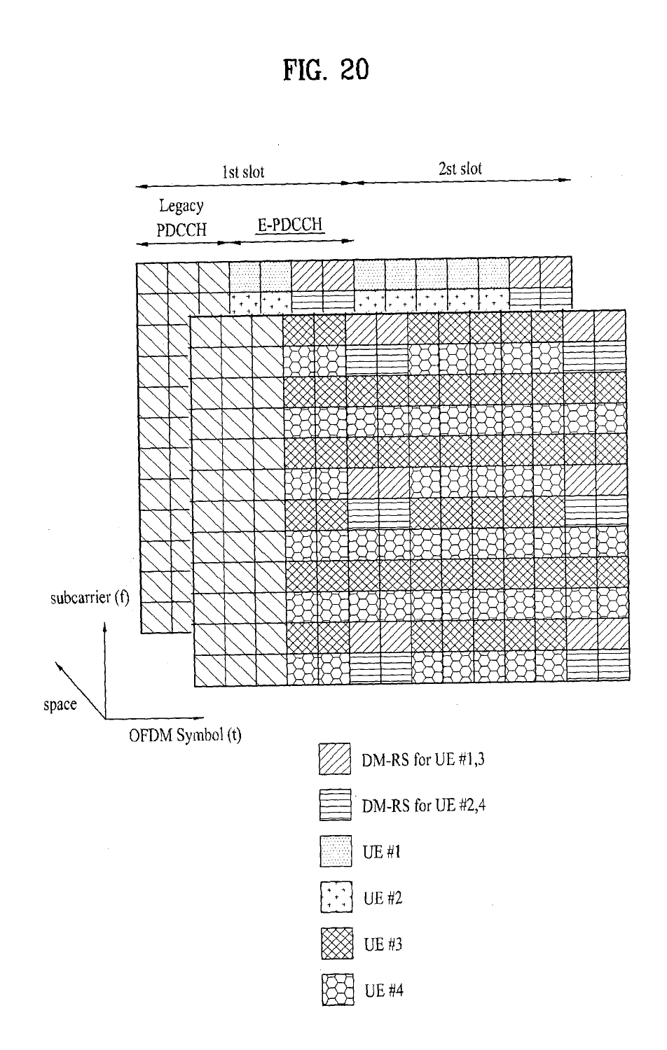

Meanwhile, by additionally applying the spatial multiplexing method in an environment, to which the third embodiment of the present invention is applied, the E-PDCCH of a larger number of user equipments may be multiplexed and transmitted. FIG. 20 illustrates another example of an E-PDCCH, which is multiplexed in accordance with the third exemplary embodiment of the present invention. Most particularly, FIG. 20 shows an example of the E-PDCCH for UE 3 and UE 4 being spatially multiplexed under the same circumstances as the example shown in FIG. 19.

In this case also, the DM-RS port allocation for the channel estimation should also be performed at the same time, as many times as the number of E-PDCCH being spatially multiplexed. For example, when the E-PDCCH transmission for each user equipment is set up as a rank 1 transmission or a transmission to one (1) layer, a total of 4 DM-RS port configurations is required for the E-PDCCH, which is multiplexed for 4 user equipments.

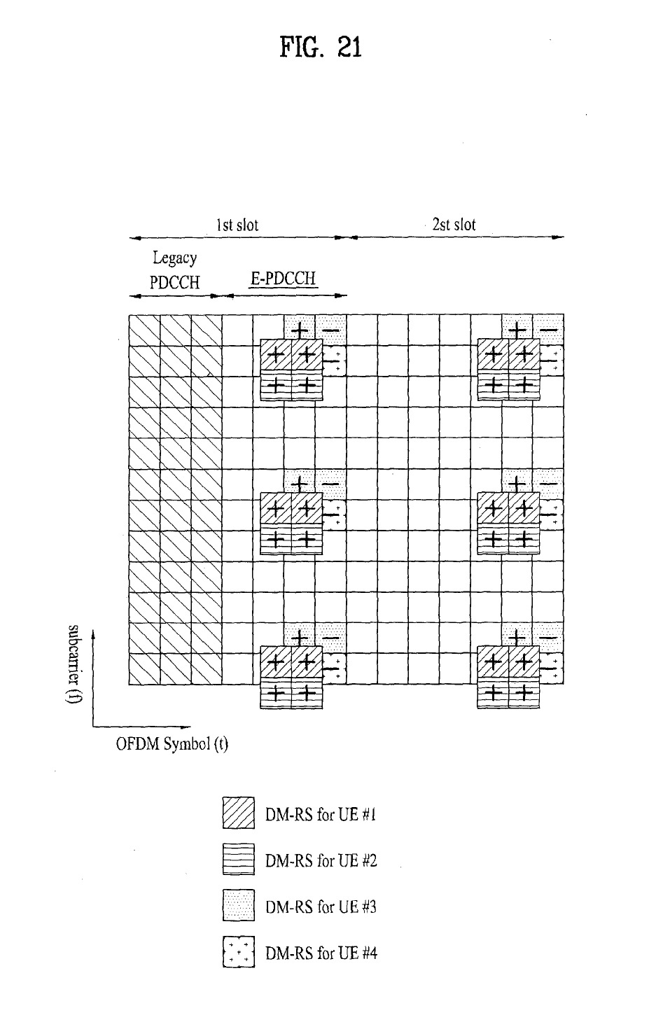

FIG. 21 illustrates an example of allocating (or assigning) a DM-RS port for each user equipment, in order to multiplex the E-PDCCH in accordance with the third exemplary embodiment of the present invention. In the current LTE system, the DM-RS may be designated with a total of 8 antenna ports so that channel estimation for a maximum of 8 layers can be performed. And, accordingly, the E-PDCCH may be spatially multiplexed and transmitted for a maximum of 8 user equipments within a single PRB.

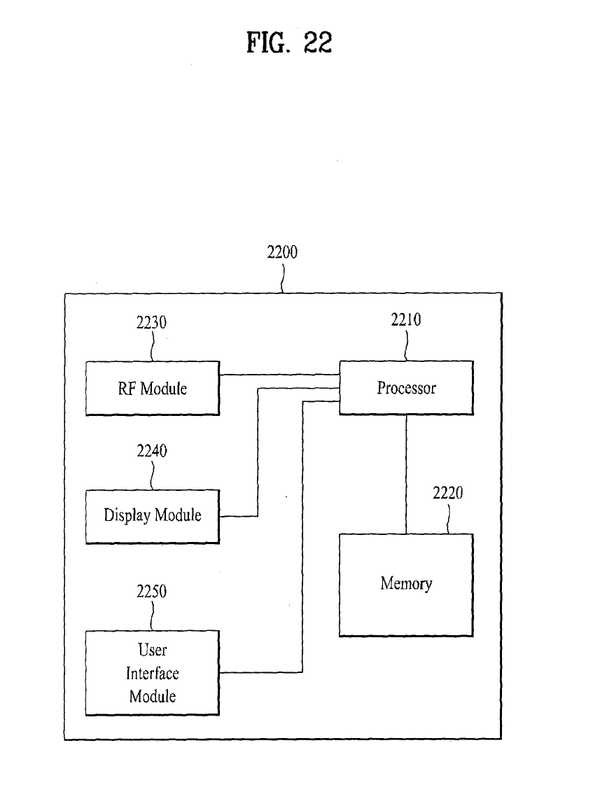

FIG. 22 illustrates a block view showing the structure of a communication device according to an exemplary embodiment of the present invention.

Referring to FIG. 22, a communication device (2200) includes a processor (2210), a memory (2220), an RF module (2230), a display module (2240), and a user interface module (2250).

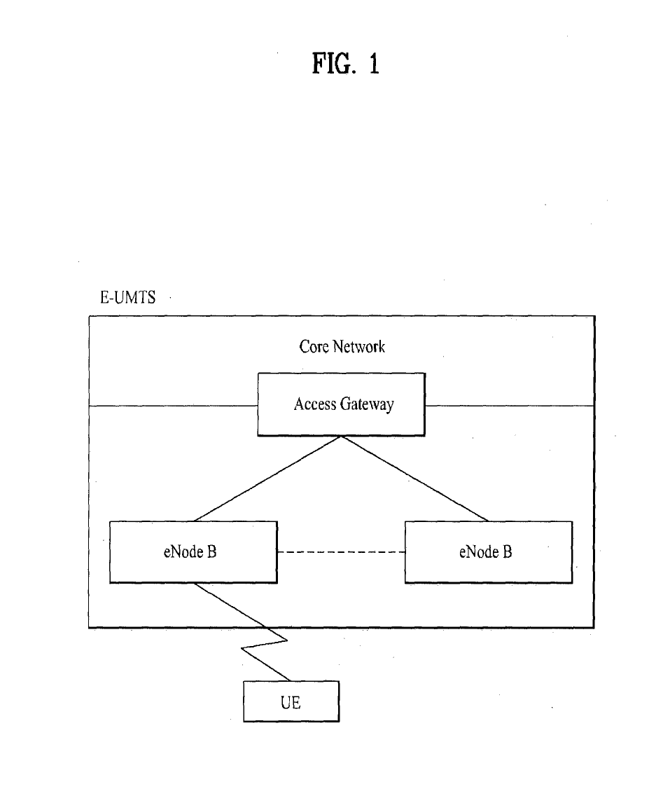

The communication device (2200) is an exemplary illustration provided to simplify the description of the present invention. Also, the communication device (2200) may further include necessary modules. Also, in the communication device (2200) some of the modules may be divided into more segmented modules. Referring to FIG. 22, an example of the processor (2210) is configured to perform operations according to the embodiment of the present invention. More specifically, for the detailed operations of the processor (2210), reference may be made to the description of the present invention shown in FIG. 1 to FIG. 16.

The memory (2220) is connected to the processor (2210) and stores operating systems, applications, program codes, data, and so on. The RF module (2230) is connected to the processor (2210) and performs a function of converting baseband signals to radio (or wireless) signals or converting radio signals to baseband signals. In order to do so, the RF module (2230) performs analog conversion, amplification, filtering, and frequency uplink conversion or inverse processes of the same. The display module (2240) is connected to the processor (2210) and displays diverse information. The display module (2240) will not be limited only to the example given herein. In other words, generally known elements, such as LCD (Liquid Crystal Display), LED (Light Emitting Diode), OLED (Organic Light Emitting Diode) may also be used as the display module (2240). The user interface module (2250) is connected to the processor (2210), and the user interface module (2250) may be configured of a combination of generally known user interfaces, such as keypads, touchscreens, and so on.

The above-described embodiments of the present invention correspond to predetermined combinations of elements and features and characteristics of the present invention. Moreover, unless mentioned otherwise, the characteristics of the present invention may be considered as optional features of the present invention. Herein, each element or characteristic of the present invention may also be operated or performed without being combined with other elements or characteristics of the present invention. Alternatively, the embodiment of the present invention may be realized by combining some of the elements and/or characteristics of the present invention. Additionally, the order of operations described according to the embodiment of the present invention may be varied. Furthermore, part of the configuration or characteristics of any one specific embodiment of the present invention may also be included in (or shared by) another embodiment of the present invention, or part of the configuration or characteristics of any one embodiment of the present invention may replace the respective configuration or characteristics of another embodiment of the present invention. Furthermore, it is apparent that claims that do not have any explicit citations within the scope of the claims of the present invention may either be combined to configure another embodiment of the present invention, or new claims may be added during the amendment of the present invention after the filing for the patent application of the present invention.

The above-described embodiments of the present invention may be implemented by using a variety of methods. For example, the embodiments of the present invention may be implemented in the form of hardware, firmware, or software, or in a combination of hardware, firmware, and/or software. In case of implementing the embodiments of the present invention in the form of hardware, the method according to the embodiments of the present invention may be implemented by using at least one of ASICs (Application Specific Integrated Circuits), DSPs (Digital Signal Processors), DSPDs (Digital Signal Processing Devices), PLDs (Programmable Logic Devices), FPGAs (Field Programmable Gate Arrays), processors, controllers, micro controllers, micro processors, and so on.

In case of implementing the embodiments of the present invention in the form of firmware or software, the method according to the embodiments of the present invention may be implemented in the form of a module, procedure, or function performing the above-described functions or operations. A software code may be stored in a memory unit and driven by a processor. Herein, the memory unit may be located inside or outside of the processor, and the memory unit may transmit and receive data to and from the processor by using a wide range of methods that have already been disclosed.

The present invention may be realized in another concrete configuration (or formation) without deviating from the scope and spirit of the essential characteristics of the present invention. Therefore, in all aspect, the detailed description of present invention is intended to be understood and interpreted as an exemplary embodiment of the present invention without limitation. The scope of the present invention shall be decided based upon a reasonable interpretation of the appended claims of the present invention and shall come within the scope of the appended claims and their equivalents. Therefore, it is intended that the present invention covers the modifications and variations of this invention provided they come within the scope of the appended claims and their equivalents, and it is not intended to limit the present invention only to the examples presented herein.

### INDUSTRIAL APPLICABILITY

Although the above-described method for multiplexing control information at a base station in a wireless communication system and an apparatus for the same are described by mainly focusing on an example applied to the 3GPP LTE system, in addition to the 3GPP LTE system, the present invention may also be applied to a wider range of wireless communication systems.

1. A method for transmitting a downlink control channel at a base station in a wireless communication system, the method comprising:
generating control information for each of a plurality of user equipments;
mapping the control information for each of the plurality of user equipments to one of subcarrier groups within at least one resource block pairs configured for the downlink control channel, wherein the subcarrier groups mapped to the control information for each of the plurality of user equipments are different from each other; and
transmitting the downlink control channel through the subcarrier groups.

2. The method of claim 1, wherein a size of each of the subcarrier groups is configured independently for each of the plurality of user equipments.

3. The method of claim 1, wherein the control information for each of the plurality of the user equipments is mapped to one of the subcarrier groups in a unit of Control Channel Element (CCE), and
wherein the number of resource elements comprising the CCE is configured independently for each of the plurality of user equipments.

4. The method of claim 1, wherein the control information for each of the plurality of user equipments is mapped to a data region of the at least one resource block pairs.

5. The method of claim 1, further comprising:
transmitting a reference signal for each of the plurality of user equipments.

6. The method of claim 5, wherein the reference signal for each of the plurality of user equipments is mapped to the subcarrier group, to which the control information for a corresponding user equipment is mapped, within the at least one resource block pairs.

7. A base station in a wireless communication system, the base station comprising:
a processor configured to generate control information for each of a plurality of user equipments, and to map the control information for each of the plurality of user equipments to one of subcarrier groups within at least one resource block pairs configured for the downlink control channel, wherein the subcarrier groups mapped to the control information for each of the plurality of user equipments are different from each other; and
a wireless communication module configured to transmit the downlink control channel through the subcarrier groups.

8. The base station of claim 7, wherein the processor configures a size of each of the subcarrier groups independently for each of the plurality of user equipments.

9. The base station of claim 7, wherein the processor maps the control information for each of the plurality of the user equipments to one of the subcarrier groups in a unit of Control Channel Element (CCE), and
wherein the processor configures the number of resource elements comprising the CCE independently for each of the plurality of user equipments.

10. The base station of claim 7, wherein the processor maps the control information for each of the plurality of user equipments to a data region of the at least one resource block pairs.

11. The base station of claim 7, wherein the wireless communication module transmits a reference signal for each of the plurality of user equipments.

12. The base station of claim 7, wherein the processor maps the reference signal for each of the plurality of user equipments to the subcarrier group, to which the control information for a corresponding user equipment is mapped, within the at least one resource block pairs.
